(19) United States
(12) Patent Application Publication
(10) Pub. No.: US 2026/0203700 A1
(43) Pub. Date: Jul. 16, 2026

(54) RISK MANAGEMENT AND ROUTE PLANNING FOR INTERNET OF THINGS (IOT) DEVICES

(71) Applicant: QUALCOMM Incorporated, San Diego, CA (US)

(72) Inventors: Avinash SHRIVASTAVA, Hyderabad (IN); Nicolas GRAUBE, Cambridge (GB); Brian MOMEYER, Escondido, CA (US); Bala RAMASAMY, San Marcos, CA (US); Bapineedu Chowdary GUMMADI, Hyderabad (IN)

(21) Appl. No.: 19/146,885

(22) PCT Filed: Feb. 5, 2024
(86) PCT No.: PCT/US2024/014491

§ 371 Date: Jul. 9, 2025

(30) Foreign Application Priority Data
Mar. 3, 2023 (IN) 202321014418

(51) Int. Cl. G06Q 10/0832

(52) U.S. Cl. CPC G06Q 10/0832

(57) ABSTRACT

Systems and techniques are described herein for route planning for delivery of assets. For example, a network entity can receive, from one or more devices associated with one or more users, one or more sets of delivery criteria for delivery of one or more assets for the one or more users. The network entity can determine delivery planning information for delivery of the one or more assets based on the one or more sets of delivery criteria. The network entity can transmit, to the one or more devices associated with the one or more users, one or more delivery notifications associated with the delivery of the one or more assets. Delivery information of the one or more delivery notifications is based on a respective level of service (e.g., a priority level of service, a basic level of service, etc.) associated with each user of the one or more users.

### FIELD

The present disclosure generally relates to route planning for delivery of assets. For example, aspects of the present disclosure are related to systems and techniques for risk management and route planning for internet of things (IoT) devices.

### BACKGROUND

Shipping and delivery of assets (e.g., items or goods) is an important activity for many users (e.g., parcel owners), which may be affiliated with various different business organizations. Currently, delivery services (e.g., transport vendors) usually make all of the necessary decisions regarding which delivery paths to take for the delivery of assets. The delivery services typically choose the delivery paths to take based on a number of different factors, which may include, for example, distance, fuel efficiency, etc. However, these chosen delivery paths may not be in the best interest of the users, who may have more specific limitations for their parcels.

Certain delivery paths to take for delivery of assets may have some inherent risks (e.g., risks related to theft, volatile climate, high power drain, no charging facilities, etc.). Sometimes, users prefer these delivery paths over other delivery paths with less inherent risks due to lower cost, shorter delivery time, etc. The users may prefer these delivery paths even though these delivery paths may result in harmful consequences occurring during the delivery of the parcel. As such, systems and techniques for risk management and route planning for delivery of parcels (e.g., for monitoring devices associated with the parcels) may be useful.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for route planning for delivery of assets. According to at least one example, a network entity associated with a delivery service is provided. The network entity includes at least one memory and at least one processor coupled to the at least one memory and configured to: receive, from one or more devices associated with one or more users, one or more sets of delivery criteria for delivery of one or more assets for the one or more users; determine delivery planning information for delivery of the one or more assets based on the one or more sets of delivery criteria; and transmit, to the one or more devices associated with the one or more users, one or more delivery notifications associated with the delivery of the one or more assets, wherein delivery information of the one or more delivery notifications is based on a respective level of service associated with each user of the one or more users.

In another illustrative example, a method of wireless communications performed at a network entity associated with a delivery service is provided. The method includes: receiving, by the network entity from one or more devices associated with one or more users, one or more sets of delivery criteria for delivery of one or more assets for the one or more users; determining, by the network entity, delivery planning information for delivery of the one or more assets based on the one or more sets of delivery criteria; and transmitting, by the network entity to the one or more devices associated with the one or more users, one or more delivery notifications associated with the delivery of the one or more assets, wherein delivery information of the one or more delivery notifications is based on a respective level of service associated with each user of the one or more users.

In another illustrative example, a non-transitory computer-readable medium having stored thereon instructions that, when executed by at least one processor, cause the at least one processor to: receive, from one or more devices associated with one or more users, one or more sets of delivery criteria for delivery of one or more assets for the one or more users; determine delivery planning information for delivery of the one or more assets based on the one or more sets of delivery criteria; and transmit, to the one or more devices associated with the one or more users, one or more delivery notifications associated with the delivery of the one or more assets, wherein delivery information of the one or more delivery notifications is based on a respective level of service associated with each user of the one or more users.

In another illustrative example, an apparatus for wireless communications is provided. The apparatus includes: means for receiving, from one or more devices associated with one or more users, one or more sets of delivery criteria for delivery of one or more assets for the one or more users; means for determining delivery planning information for delivery of the one or more assets based on the one or more sets of delivery criteria; and means for transmitting, to the one or more devices associated with the one or more users, one or more delivery notifications associated with the delivery of the one or more assets, wherein delivery information of the one or more delivery notifications is based on a respective level of service associated with each user of the one or more users.

In another illustrative example, a device associated with a user is provided. The device includes at least one memory and at least one processor coupled to the at least one memory and configured to: transmit, to a network entity associated with a delivery service, a set of delivery criteria comprising delivery instructions for delivery of one or more assets for the user; and receive, from the network entity, a delivery notification comprising delivery information, wherein an amount of the delivery information in the delivery notification is based on a level of service associated with the user.

In another illustrative example, a method of wireless communications performed at a device is provided. The method includes: transmitting, by the device to a network entity associated with a delivery service, a set of delivery criteria comprising delivery instructions for delivery of one or more assets for the user; and receiving, by the device from the network entity, a delivery notification comprising delivery information, wherein an amount of the delivery information in the delivery notification is based on a level of service associated with the user.

In another illustrative example, a non-transitory computer-readable medium having stored thereon instructions that, when executed by at least one processor, cause the at least one processor to: transmit, to a network entity associated with a delivery service, a set of delivery criteria comprising delivery instructions for delivery of one or more assets for the user; and receive, from the network entity, a delivery notification comprising delivery information, wherein an amount of the delivery information in the delivery notification is based on a level of service associated with the user.

In another illustrative example, an apparatus for wireless communications is provided. The apparatus includes: means for transmitting, to a network entity associated with a delivery service, a set of delivery criteria comprising delivery instructions for delivery of one or more assets for the user; and means for receiving, from the network entity, a delivery notification comprising delivery information, wherein an amount of the delivery information in the delivery notification is based on a level of service associated with the user.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram of user equipment (UE), in accordance with aspects of the present disclosure.

FIG. 2 illustrates an example wireless communications system, in accordance with aspects of the present disclosure.

FIG. 3 illustrates an example implementation of a system-on-a-chip (SOC), in accordance with aspects of the present disclosure.

FIG. 4 is a diagram illustrating an example of a network of trackers on a delivery vehicle, in accordance with aspects of the present disclosure.

FIG. 5 is a diagram illustrating an example of a system for sensor sharing in vehicle-to-everything (V2X) communications, in accordance with aspects of the present disclosure.

FIG. 6 is a diagram illustrating an example of a vehicle-based message, in accordance with aspects of the present disclosure.

FIG. 7 is a diagram illustrating an example of a system for risk management and route planning for internet of things (IoT) devices in accordance with aspects of the present disclosure.

FIG. 8 is a table illustrating example risk factors that may be notified (or not notified) to users with different levels of service, in accordance with aspects of the present disclosure.

FIG. 9 is a flow chart illustrating an example of a process for wireless communications at a network entity, in accordance with aspects of the present disclosure.

FIG. 10 is a flow chart illustrating an example of a process for wireless communications at a device, in accordance with aspects of the present disclosure.

FIG. 11 is a block diagram illustrating an example of a computing system, which may be employed by the disclosed systems and techniques, in accordance with aspects of the present disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

As previously mentioned, shipping and delivery of assets (e.g., items or goods) can be an important activity for many users (e.g., parcel owners). Currently, delivery services (e.g., transport vendors) make necessary decisions regarding which delivery paths to take for delivery of the assets. These delivery services generally choose the delivery paths to use for delivery based on different factors, which may include, for example, distance, fuel efficiency, etc. However, these chosen delivery paths may not always be in the best interest of the users, who may have more specific limitations for their parcels.

Certain delivery paths to take for delivery of assets can have some inherent risks (e.g., risks related to theft, volatile climate, high power drain, no charging facilities, etc.). Users may prefer these delivery paths as opposed to other delivery paths with less inherent risks because the users would like a lower cost, a shorter delivery time, etc. The users may prefer these delivery paths even though these delivery paths can result in harmful consequences occurring during the delivery.

Systems and techniques are described herein for providing risk management and route planning for delivery of parcels (e.g., for monitoring/tracking devices associated with the parcels). The systems and techniques can provide solutions that allow for a user (e.g., parcel owner) to have options to provide specific delivery instructions and/or to allow (or not allow) for risk factors associated with the parcel and possible outcomes due to external environmental changes.

In one or more examples, when the users are placing their delivery orders to a delivery service (e.g., transport vendor) for delivery of their assets (e.g., within parcels) to their destination locations, the users can select a level of service, which may be a more costly, priority level of service or a less expensive basic level of service. In some examples, the users may have previously subscribed to the priority level of service or to the basic level of service for future deliveries of their assets for a predetermined duration of time for the subscription.

After having selected or subscribed to a specific level of service, users can provide their own delivery instructions to the delivery service, when the users are placing their delivery orders. Users may provide more delivery instructions when the users have the priority level of service as opposed to the basic level of service.

After the delivery service has received the delivery instructions from the users, the delivery service may gather all of the risk factors that are related to potential delivery paths for delivery of the assets to their destination locations. The delivery service may then perform delivery planning to determine delivery planning information (e.g., which may include the delivery paths to use and times of delivery) for delivery of the assets to their destination locations. The delivery service can determine this delivery planning information by using (e.g., based on) the received delivery instructions from the users; optionally, the risk factors related to the different potential delivery paths; and optionally, the levels of service of the users.

During delivery of the assets to the destination locations, the delivery service may send (e.g., transmit) delivery notifications to the users regarding the delivery of their assets. The delivery notifications sent to users with a priority level of service may include more delivery information than the delivery notifications sent to users with a basic level of service. In one or more examples, delivery notifications sent to users with a priority level of service may include delivery information that may include, but is not limited to, a time of delivery and a delivery path. In some examples, delivery notifications sent to users with a priority level of service may include delivery information that may further include, but is not limited to, environmental information, temperature information, a battery percentage of an associated monitoring device (also referred to as a tracking device or tracker), delivery substation details, fuel details, a type of delivery vehicle, and/or a change in the delivery path.

In some examples, insurance companies can charge differently for the different delivery paths and the delivery path information can be shared with the insurance companies as well. For example, different premiums may be charged by the insurance companies for different delivery paths (e.g., even for the same destination location for the parcel) and/or for different damage claims for different paths. Insurance companies may also need some kind of surety. In one or more examples, insurance companies can receive a benefit from the systems and techniques by being able to implement a tariff plan based on the different risk factors associated with the different delivery paths. Utilizing the risk factors for the different delivery paths can also be beneficial to the insurance companies to determine insurance premiums and/or claim amounts for a particular delivery.

In one or more examples, the delivery service (e.g., transport vendor) can segregate (or conversely combine) parcels (e.g., containing assets) according to the associated risk factors and, optionally, cost factors related to the different delivery paths. In some examples, pallets of multiple delivery services (e.g., transport vendors) can be combined together to be transported by a single delivery service (e.g., transport vendor).

In one or more aspects, the delivery service can perform effective route planning (e.g., by determining efficient paths and effective modes of transport for delivery, such as a choice of a type of delivery vehicle) based on the level of service of the users, which may have assets with different destination locations. The systems and techniques provide for transparency between the user (e.g., parcel owner) and the delivery service (e.g., transport vendor). The users can be satisfied customers when the delivery service adheres to their delivery instructions for delivery of their assets to their destination locations. In some examples, the delivery service (e.g., transport company) may provide, during the delivery to the user, an alternative option (e.g., an option for an alternative delivery vehicle and/or an option for an alternative delivery path) when there is a sudden change (e.g., environmental impact, bad road infrastructure, etc.) in the current delivery path. In one or more examples, users (e.g., with a priority level of service) can reject (e.g., cancel) the deliveries of their assets, when the delivery service (e.g., transport vendor) has not strictly adhered to the users' delivery instructions. In these examples, the delivery service (e.g., transport vendor) can identify one or more storage facilities where the assets of the rejected deliveries can be stored.

Additional aspects of the present disclosure are described in more detail below with respect to the figures.

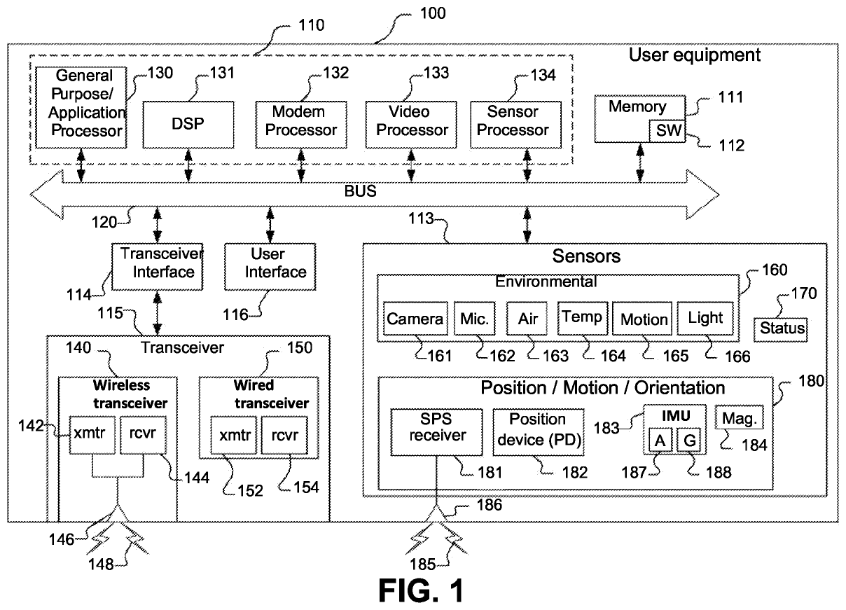

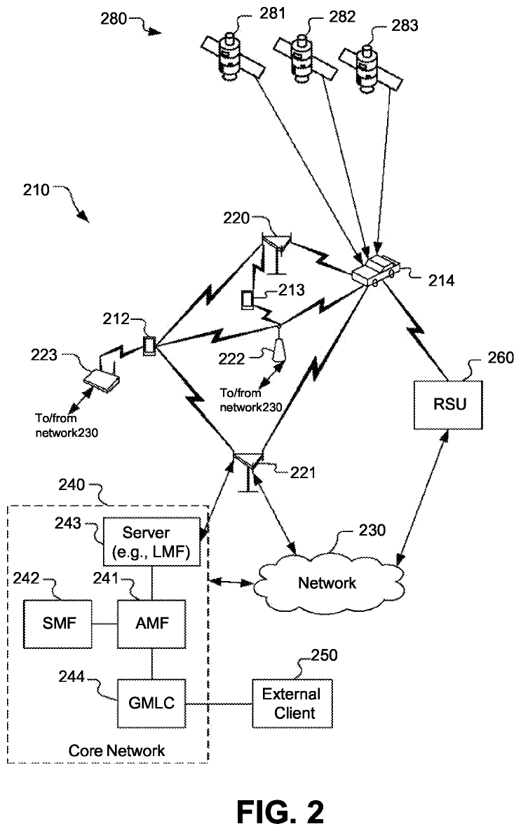

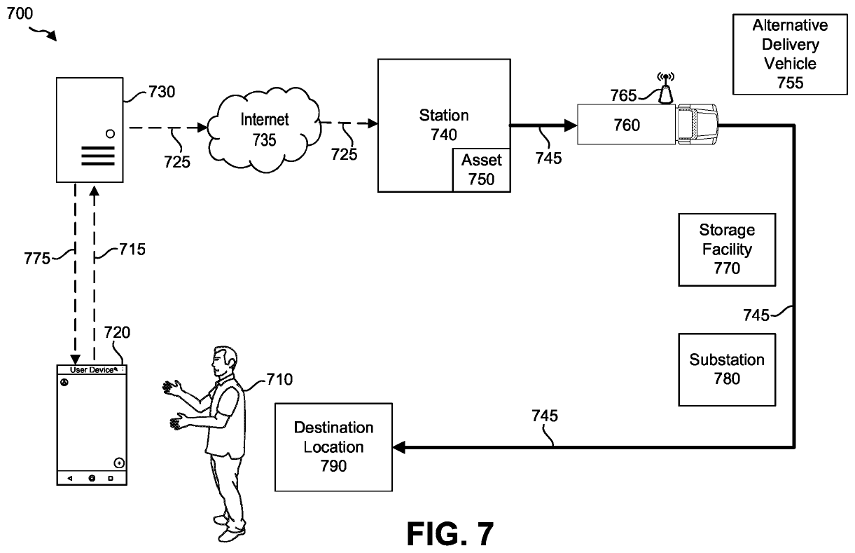

FIG. 1 is a block diagram of a UE 100, in accordance with aspects of the present disclosure. UE 100 may be an example of any of the UEs 212, 213, 214 (as shown in FIG. 2) or device 720 of FIG. 7 (e.g., a UE shown in the form of a smart phone). UE 100 may include a computing platform including a processor 110, memory 111 including software (SW) 112, one or more sensors 113, a transceiver interface 114 for a transceiver 115 (that includes a wireless transceiver 140 and a wired transceiver 150), and a user interface 116. The processor 110, the memory 111, the sensor(s) 113, the transceiver interface 114, and the user interface 116 may be communicatively coupled to each other by a bus 120 (which may be configured, e.g., for optical and/or electrical communication). One or more of the components shown (e.g., one or more of the sensors 113, etc.) may be omitted from the UE 100.

The processor 110 may include one or more intelligent hardware devices, e.g., a central processing unit (CPU), a microcontroller, an application specific integrated circuit (ASIC), etc. The processor 110 may comprise multiple processors including a general-purpose/application processor 130, a Digital Signal Processor (DSP) 131, a modem processor 132, a video processor 133, and/or a sensor processor 134. One or more of the processors 130-134 may comprise multiple devices (e.g., multiple processors). For example, the sensor processor 134 may comprise one or more processors for processing data from RF-based sensors, ultrasound-based sensors, and/or light-based sensors, etc. The modem processor 132 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 100 for connectivity. The memory 111 is a non-transitory storage medium that may include random access memory (RAM), flash memory, disc memory, and/or read-only memory (ROM), etc. The memory 111 stores the software 112 which may be processor-readable, processor-executable software code containing instructions that are configured to, when executed, cause the processor 110 to perform various functions described herein. Alternatively, the software 112 may not be directly executable by the processor 110 but may be configured to cause the processor 110, e.g., when compiled and executed, to perform the functions. The description may refer only to the processor 110 performing a function, but this includes other implementations such as where the processor 110 executes software and/or firmware. The description may refer to the processor 110 performing a function as shorthand for one or more of the processors 130-134 performing the function. The description may refer to the UE 100 performing a function as shorthand for one or more appropriate components of the UE 100 performing the function. The processor 110 may include a memory with stored instructions in addition to and/or instead of the memory 111. Functionality of the processor 110 is discussed more fully below.

The configuration of the UE 100 shown in FIG. 1 is an example and not limiting of the aspects and features of the disclosure, including the claims, and other configurations may be used. For example, an example configuration of the UE includes one or more of the processors 130-134 of the processor 110, the memory 111, and the wireless transceiver 140. Other example configurations include one or more of the processors 130-134 of the processor 110, the memory 111, the wireless transceiver 140, and one or more of the sensors 113, the user interface 116, and/or the wired transceiver 150.

The UE 100 may comprise the modem processor 132 that may be capable of performing baseband processing of signals received and down-converted by the transceiver 115 and/or the SPS receiver 181 (discussed below). The modem processor 132 may perform baseband processing of signals to be upconverted for transmission by the transceiver 115. Also or alternatively, baseband processing may be performed by the processor 130 and/or the DSP 131. Other configurations, however, may be used to perform baseband processing.

The UE 100 includes the sensors 113 that may include one or more of various types of sensors, for example, an environmental sensor 160, a status sensor 170, and a position/motion/orientation (PMO) sensor 180. The PMO sensor 180 may include one or more sensors from which position and/or motion and/or orientation of the UE 100 may be determined. While each of the sensors 160, 170, 180 may be referred to in the singular, each of the sensors 160, 170, 180 may include more than one sensor, examples of some of which are discussed explicitly herein. The sensors 113 may generate analog and/or digital signals indications of which may be stored in the memory 111 and processed by the processor 110 (e.g., the processor 130, the DSP 131, the video processor 133, and/or the sensor processor 134 as appropriate) in support of one or more applications such as, for example, applications directed to positioning, navigation, and/or resource management. The description herein may refer to the processor 110 generally as performing one or more functions that one or more of the processors 130-134 perform.

The sensor(s) 113 may be used in resource management, relative location measurements, relative location determination, motion determination, etc. Information detected by the sensor(s) 113 may be used to determine how to allocate resources of the UE 100, e.g., transmission power, processing power for transmission and/or reception of communication signals, transmission and/or reception directionality, etc. The plural term “resources” is often used throughout the discussion herein, but this term includes the singular as well, i.e., a single resource, e.g., being allocated. Also or alternatively, information detected by the sensor(s) may be used for motion detection, relative displacement, dead reckoning, sensor-based location determination, and/or sensor-assisted location determination. The sensor(s) 113 may be useful to determine whether the UE 100 is fixed (stationary) or mobile and/or whether to report certain useful information to the server 243 (as shown in FIG. 2) regarding the mobility of the UE 100. For example, based on the information obtained/measured by the sensor(s) 113, the UE 100 may notify/report to the server 243 of FIG. 2 that the UE 100 has detected movements or that the UE 100 has moved, and report the relative displacement/distance (e.g., via dead reckoning, or sensor-based location determination, or sensor-assisted location determination enabled by the sensor(s) 113). In another example, for relative positioning information, the sensors/IMU can be used to determine the angle, size (e.g., width and/or height), and/or orientation of another device with respect to the UE 100, etc. The position and/or motion of the UE 100 may be used in determining resource allocation for communication, e.g., between vehicles. The UE 100 may, for example, be disposed in or integrated with a vehicle. For example, the UE 100 may be the UE 214 of FIG. 2, which is a vehicle (e.g., a car) in the example shown in FIG. 2. Other forms of UEs or vehicles may be used, such as trucks (e.g., delivery vehicle 760 of FIG. 7), air-based UEs (e.g., alternative delivery vehicle 755 of FIG. 7), etc. As such, the UE 100 may be configured for various forms of communication, e.g., V2V (vehicle-to-vehicle), V2X (vehicle-to-everything), CV2X (cellular V2X), CV2V (cellular V2V), etc.

The environmental sensor 160 may include one or more sensors for measuring one or more internal and/or external environmental conditions. In this example, the environmental sensor 160 includes a camera 161, a microphone 162, an air-flow sensor 163, a temperature sensor 164, a motion sensor 165, and a light-based sensor 166. While each of the sensors 161-166 may be referred to in the singular, each of the sensors 161-166 may include more than one sensor, examples of some of which are discussed explicitly herein. For example, the camera 161 may include at least one camera configured (e.g., designed, made, disposed, and directed) to capture images external to the UE 100 and/or may include one or more cameras configured to capture images internal to the UE 100 (e.g., in a passenger compartment of a vehicle). As other examples, the microphone 162, the temperature sensor 164, and/or the motion sensor 165 may include multiple microphones, multiple thermometers, and/or multiple motion detectors configured to detect sound, temperature, and/or motion (respectively) outside and/or inside of the UE 100, e.g., a vehicle. Indeed, any of the sensors 161-165 may include multiple respective sensors outside the vehicle and/or multiple respective sensors inside the vehicle for making respective measurements at multiple locations about the vehicle and/or in different directions relative to the vehicle. While this discussion assumes the UE 100 is a vehicle, the UE 100 may be a different device (i.e., other than a vehicle). The sensors 161-165 are examples and one or more of the sensors 161-165 may be omitted from the UE 100 and/or one or more other sensors may be included in the UE 100. For example, the environmental sensor 160 may include one or more barometric pressure sensors and/or one or more ambient light sensors and/or one or more other sensors.

The camera 161 may be configured for capturing still and/or moving imagery. For example, each camera of the camera 161 may comprise, for example, one or more imaging sensors (e.g., a charge coupled device (CCD) or a CMOS imager), one or more lenses, analog-to-digital circuitry, frame buffers, etc. Additional processing, conditioning, encoding, and/or compression of signals representing captured images may be performed by the general-purpose processor 130 and/or the DSP 131. Also or alternatively, the video processor 133 may perform conditioning, encoding, compression, and/or manipulation of signals representing captured images. The video processor 133 may decode/decompress stored image data for presentation on a display device (not shown), e.g., of the user interface 116.

The motion detector 165 is configured to detect motion. For example, the motion detector 165 may send and receive sound waves (e.g., ultrasound signals) and analyze the received signals for Doppler effects indicative of motion. Use of multiple motion detectors may help identify the relative location (e.g., direction relative to the UE 100) of an object.

The light-based sensor 166 is configured to determine range to an object, which may be used by the processor 110 to detect the presence of an object. Use of multiple light-based sensors may help identify the relative location (e.g., direction relative to the UE 100) of an object. In some cases, the light-based sensor 166 may be used for detecting relatively small objects such as vehicles or other artificial (human-made) objects.

The status sensor 170 is configured to provide one or more indications of one or more UE conditions of the UE 100 indicative of UE status. For example, UE conditions where the UE 100 is a vehicle (with UE conditions thus being vehicle conditions) may include a gear status of the vehicle (e.g., whether the vehicle is in park, drive, or neutral, or in which gear the vehicle is presently (e.g., reverse, first, second, third, fourth, etc.)). Another vehicle condition may be whether an emergency brake is engaged. Another vehicle condition may be whether a main brake is presently engaged and possibly engaged to what degree. Another vehicle condition may be whether an accelerator is presently engaged and possibly to what degree. Another vehicle condition may be the status of the steering wheel (e.g., turned which way and how much) and/or wheel(s) directing the vehicle (e.g., direction of front wheels). Other example vehicle conditions may include whether a right-turn indicator is actuated, whether a left-turn indicator is actuated, and/or whether hazard lights (also called “four ways” or emergency flashers, etc.) are actuated. Another example vehicle condition may include tire status (e.g., tire pressure, rate of tire pressure change (e.g., to indicate a flat or blowout)). Another example vehicle condition is speed, e.g., as registered by a speedometer of the vehicle and/or determined by other means (e.g., using the PMO sensor 180). These vehicle conditions are examples, and one or more other sensors may be provided to sense one or more other vehicle conditions. Further, numerous other UE conditions may be sensed and indicated where the UE 100 is not a vehicle or is not associated with a vehicle.

The PMO sensor 180 may include one or more sensors for providing one or more UE conditions such as, for example, vehicle conditions. For example, the PMO sensor 180 may include one or more sensors for measuring information from which position and/or motion and/or orientation of the UE 100 may be determined and possibly determining position and/or motion (e.g., speed and/or direction of motion) and/or orientation of the UE 100. In this example, the PMO sensor 180 includes a Satellite Positioning System (SPS) receiver 181, a position device (PD) 182, an Inertial Measurement Unit (IMU) 183, and a magnetometer 184. The components of the PMO sensor 180 shown are examples, and one or more of these components may be omitted and/or one or more other components included in the PMO sensor 180. Also, while each of the components 181-184 of the PMO sensor 180 may be referred to in the singular, each of the components 181-184 may include more than one such component, examples of some of which are discussed explicitly herein. Also, the PD 182 may be part of the SPS receiver 181 and/or the IMU 183 and/or part of the processor 110, and may not be a sensor itself (e.g., may not take measurements), but may process information from one or more of the sensors 181, 183, 184 and/or one or more other sensors. The PMO 180 may be used to determine UE speed and/or direction of motion, e.g., by determining UE location over time (e.g., determined using SPS, one or more ranging sensors, etc.).

The IMU 183 may comprise one or more inertial sensors, for example, an accelerometer 187 (e.g., responding to acceleration of the UE 100 in three dimensions) and/or a gyroscope 188. While each of the sensors 187, 188 may be referred to in the singular, each of the sensors 187, 188 may include more than one sensor. The accelerometer may include one or more three-dimensional accelerometers and the gyroscope may include one or more three-dimensional gyroscopes. The IMU 183 may be configured to provide measurements about a direction of motion and/or a speed of motion of the UE 100, which may be used, for example, in relative location determination. For example, the accelerometer 187 and/or the gyroscope 188 of the IMU 183 may detect, respectively, a linear acceleration and a speed of rotation of the UE 100. The linear acceleration and speed of rotation measurements of the UE 100 may be integrated over time (e.g., by the IMU 183 and/or the PD 182) to determine an instantaneous direction of motion as well as a displacement of the UE 100. The instantaneous direction of motion and the displacement may be integrated to track a location of the UE 100. For example, a reference location of the UE 100 may be determined, e.g., using the SPS receiver 181 (and/or by some other means) for a moment in time and measurements from the accelerometer 187 and the gyroscope 188 taken after this moment in time may be used in dead reckoning to determine a present location of the UE 100 based on movement (direction and distance) of the UE 100 relative to the reference location.

The magnetometer 184 may determine magnetic field strengths in different directions which may be used to determine orientation of the UE 100, which may be used, for example, to provide a digital compass for the UE 100. The magnetometer 184 may include a two-dimensional magnetometer configured to detect and provide indications of magnetic field strength in two orthogonal dimensions. Also or alternatively, the magnetometer 184 may include a three-dimensional magnetometer configured to detect and provide indications of magnetic field strength in three orthogonal dimensions. The magnetometer 184 may provide means for sensing a magnetic field and providing indications of the magnetic field (e.g., to the processor 110). The magnetometer 184 may provide measurements to determine orientation (e.g., relative to magnetic north and/or true north) that may be used for any of a variety of purposes (e.g., to support one or more compass applications). While referred to in the singular, the magnetometer 184 may include multiple magnetometers.

The SPS receiver 181 (e.g., a Global Positioning System (GPS) receiver or other Global Navigation Satellite System (GNSS) receiver) may be capable of receiving and acquiring SPS signals 185 via an SPS antenna 186. The antenna 186 is configured to transduce the wireless SPS signals 185 to wired signals (e.g., electrical or optical signals, and may be integrated with the antenna 146). The SPS receiver 181 may be configured to process, in whole or in part, the acquired SPS signals 185 for estimating a location of the UE 100. For example, the SPS receiver 181 may be configured to determine location of the UE 100 by trilateration using the SPS signals 185. The general-purpose processor 130, the memory 111, the DSP 131 and/or one or more specialized processors (not shown) may be utilized to process acquired SPS signals, in whole or in part, and/or to calculate an estimated location of the UE 100, in conjunction with the SPS receiver 181. The memory 111 may store indications (e.g., measurements) of the SPS signals 185 and/or other signals (e.g., signals acquired from the wireless transceiver 140) for use in performing positioning operations. The general-purpose processor 130, the DSP 131, and/or one or more specialized processors, and/or the memory 111 may provide or support a location engine for use in processing measurements to estimate a location of the UE 100. Also or alternatively, some or all of the position determination signal processing may be performed by the PD 182.

The position device (PD) 182 may be configured to determine a position of the UE 100 (including absolute and/or relative position of the UE 100), motion of the UE 100, and/or time. For example, the PD 182 may communicate with, and/or include some or all of, the SPS receiver 181. The PD 182 may use measurements from the SPS receiver 181 and/or the IMU 183 and/or the magnetometer 184 to determine position and/or motion of the UE 100, e.g., using trilateration and/or dead reckoning. The PD 182 may work in conjunction with the processor 110 and the memory 111 as appropriate to perform at least a portion of one or more positioning methods (to determine location of the UE 100), although the description herein may refer only to the PD 182 being configured to perform, or performing, one or more operations in accordance with the positioning method(s). The PD 182 may also or alternatively be configured to determine location of the UE 100 using terrestrial-based signals (e.g., at least some of signals 148 discussed below) for trilateration, for assistance with obtaining and using the SPS signals 185, or both. The PD 182 may be configured to use one or more other techniques (e.g., relying on the UE's self-reported location (e.g., part of the UE's position beacon)) for determining the location of the UE 100, and may use a combination of techniques (e.g., SPS and terrestrial positioning signals) to determine the location of the UE 100. The PD 182 may be configured to provide indications of uncertainty and/or error in the determined position and/or motion. Functionality of the PD 182 may be provided in a variety of manners and/or configurations (e.g., by the general purpose/application processor 130, the transceiver 115, the SPS receiver 181, and/or another component of the UE 100, and may be provided by hardware, software, firmware, or various combinations thereof).

The transceiver 115 may include a wireless transceiver 140 and/or a wired transceiver 150 configured to communicate with other devices through wireless connections and wired connections, respectively. For example, the wireless transceiver 140 may include a wireless transmitter 142 and a wireless receiver 144 coupled to one or more antennas 146 for transmitting (e.g., on one or more uplink channels and/or one or more sidelink channels) and/or receiving (e.g., on one or more downlink channels and/or one or more sidelink channels) wireless signals 148 and transducing signals from the wireless signals 148 to wired (e.g., electrical and/or optical) signals and from wired signals to the wireless signals 148. The wireless transceiver 140 may be configured for wireless communication to send communications to, and receive communications from, a variety of entities such as other UEs, base stations, etc. Thus, the wireless transmitter 142 may include multiple transmitters that may be discrete components or combined/integrated components, and/or the wireless receiver 144 may include multiple receivers that may be discrete components or combined/integrated components. The wireless transceiver 140 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6GHz frequencies. The wired transceiver 150 may include a wired transmitter 152 and a wired receiver 154 configured for wired communication, e.g., a network interface that may communicate with the network 230 of FIG. 2, e.g., to send communications to, and receive communications from, a gNB, for example. The wired transmitter 152 may include multiple transmitters that may be discrete components or combined/integrated components, and/or the wired receiver 154 may include multiple receivers that may be discrete components or combined/integrated components. The wired transceiver 150 may be configured, e.g., for optical communication and/or electrical communication. The transceiver 115 may be communicatively coupled to the transceiver interface 114, e.g., by optical and/or electrical connection. The transceiver interface 114 may be at least partially integrated with the transceiver 115.

The wireless transceiver 140 may be configured for beam management to affect directionality of the wireless transceiver 140, e.g., of the antenna 146. For example, the wireless transceiver 140 may be configured to implement beam forming for transmission and/or reception of the signals 148. The antenna 146 may include multiple antennas that are configured, e.g., designed, made, disposed, and directed to point in different directions relative to a body of the UE 100. One or more of such antennas may be capable of electronic beam steering (e.g., using appropriate phase shifts of elements of the antenna) and/or mechanical beam steering. Also or alternatively, the transceiver 140 may be configured to selectively (e.g., under direction/control of the processor 110) transmit from one or more antennas and/or to selectively process signals (e.g., to pass from the transceiver 115 to the processor 110 or to process by the processor 110) received from one or more antennas.

The user interface 116 may comprise one or more of several devices such as, for example, a speaker, microphone, display device, vibration device, keyboard, touch screen, etc. The user interface 116 may include more than one of any of these devices. The user interface 116 may be configured to enable a user to interact with one or more applications hosted by the UE 100. For example, the user interface 116 may store indications of analog and/or digital signals in the memory 111 to be processed by DSP 131 and/or the general-purpose processor 130 in response to action from a user. Similarly, applications hosted on the UE 100 may store indications of analog and/or digital signals in the memory 111 to present an output signal to a user. The user interface 116 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 116 may comprise one or more touch sensors responsive to touching and/or pressure, e.g., on a keyboard and/or touch screen of the user interface 116.

FIG. 2 illustrates an example wireless communications system 210, in accordance with aspects of the present disclosure. Wireless communications system 210 includes a user equipment (UE) 212, a UE 213, a UE 214, base transceiver stations (BTSs) 220, 221, 222, 223, a network 230, a core network 240, an external client 250, and a roadside unit (RSU) 260. The core network 240 (e.g., a 5G core network (5GC)) may include back-end devices including, among other things, an Access and Mobility Management Function (AMF) 241, a Session Management Function (SMF) 242, a server 243, and a Gateway Mobile Location Center (GMLC) 244. The AMF 241, the SMF 242, the server 243, and the GMLC 244 are communicatively coupled to each other. The server 243 may be, for example, a Location Management Function (LMF) that supports positioning of the UEs 212-214 (e.g., using techniques such as Assisted Global Navigation Satellite System (A-GNSS), OTDOA (Observed Time Difference of Arrival, e.g., Downlink (DL) OTDOA and/or Uplink (UL) OTDOA), Round Trip Time (RTT), Multi-Cell RTT, RTK (Real Time Kinematic), PPP (Precise Point Positioning), DGNSS (Differential GNSS), E-CID (Enhanced Cell ID), AoA (Angle of Arrival), AoD (Angle of Departure), etc.). The RSU 260 may be configured for communication (e.g., bi-directional or uni-directional communication) with the UEs 212-214). For example, the RSU 260 may be configured with similar communication capabilities to any of the BTSs 220-223, but perhaps with different functionality(ies) (e.g., different programming). Also, while one RSU 260 is shown in FIG. 2, the system 200 may include more than one RSU, or may not include any RSUs. The communication system 210 may include additional or alternative components.

The communication system 210 may utilize information from a constellation 280 of satellite vehicles (SVs) 281, 282, 283. The constellation 280 may correspond to a respective Global Navigation Satellite System (GNSS) (i.e., Satellite Positioning System (SPS)) such as the Global Positioning System (GPS), the GLObal NAvigation Satellite System (GLONASS), Galileo, Beidou, or some other local or regional SPS such as the Indian Regional Navigational Satellite System (IRNSS), the European Geostationary Navigation Overlay Service (EGNOS), or the Wide Area Augmentation System (WAAS). Only three SVs are shown for the constellation 280, but constellations of GNSS SVs will include more than three SVs.

An LMF may also be referred to as a Location Manager (LM), a Location Function (LF), a commercial LMF (CLMF), or a value-added LMF (VLMF). The server 243 (e.g., an LMF) and/or one or more other devices of the system 210 (e.g., one or more of the UEs 212-214) may be configured to determine locations of the UEs 212-214. The server 243 may communicate directly with the BTS 221 (e.g., a gNB) and/or one or more other BTSs, and may be integrated with the BTS 221 and/or one or more other BTSs. The SMF 242 may serve as an initial contact point of a Service Control Function (SCF) (not shown) to create, control, and delete media sessions. The server 243 (e.g., an LMF) may be co-located or integrated with a gNB or a TRP (Transmission/Reception Point), or may be disposed remote from the gNB and/or TRP and configured to communicate directly or indirectly with the gNB and/or the TRP.

The AMF 241 may serve as a control node that processes signaling between the UEs 212-214 and the core network 240, and provides QoS (Quality of Service) flow and session management. The AMF 241 may support mobility of the UEs 212-214 including cell change and handover and may participate in supporting signaling connection to the UEs 212-214.

The system 210 is capable of wireless communication in that components of the system 210 can communicate with one another (at least some times using wireless connections) directly or indirectly, e.g., via the BTSs 220-223 and/or the network 230 (and/or one or more other devices not shown, such as one or more other base transceiver stations). While the BTSs 220-223 are shown separately from the network 230, the network 230 may include one or more of the BTSs 220-223 and may constitute a Radio Access Network (RAN), e.g., a New Radio (NR) RAN which may also be called a Fifth Generation (5G) Next Generation (NG) RAN (NG-RAN). For indirect communications, the communications may be altered during transmission from one entity to another, e.g., to alter header information of data packets, to change format, etc. The UEs 212-214 may communicate with the BTSs 220-223 via Uu interfaces, e.g., in RRC-encapsulated LPP messages (Radio Resource Control encapsulated LTE Positioning Protocol messages) over Uu interfaces. The UEs 212-214 shown are a smartphone, a tablet computer, and a vehicle-based device, but these are examples only as the UEs 212-214 are not required to be any of these configurations, and other configurations of UEs may be used. The UEs 212-214, the BTSs 220-223, the network 230, the core network 240, and/or the external client 250. For example, such other devices may include internet of thing (IoT) devices, medical devices, home entertainment and/or automation devices, etc. The core network 240 may communicate with the external client 250 (e.g., a computer system), e.g., to allow the external client 250 to request and/or receive location information regarding the UEs 212-214 (e.g., via the GMLC 244).

The UEs 212-214 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long-Term Evolution), V2X (e.g., V2P (Vehicle-to-Pedestrian), V2I (Vehicle-to-Infrastructure), V2V (Vehicle-to-Vehicle), etc.), IEEE 802.81p, etc.). V2X communications may be cellular (Cellular-V2X (C-V2X)) and/or WiFi (e.g., DSRC (Dedicated Short-Range Connection)). The system 210 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc.

The BTSs 220-223 may wirelessly communicate with the UEs 212-214 in the system 210 via one or more antennas. A BTS may also be referred to as a base station, an access point, a gNode B (gNB), an access node (AN), a Node B, an evolved Node B (eNB), etc. For example, each of the BTSs 220, 221 may be a gNB or a transmission point gNB, the BTS 222 may be a macro cell (e.g., a high-power cellular base station) and/or a small cell (e.g., a low-power cellular base station), and the BTS 223 may be an access point (e.g., a short-range base station configured to communicate with short-range technology such as WiFi, WiFi-Direct (WiFi-D), Bluetooth®, Bluetooth®-low energy (BLE), Zigbee, etc. One or more of the BTSs 220-223 may be configured to communicate with the UEs 212-214 via multiple carriers. Each of the BTSs 220, 221 may provide communication coverage for a respective geographic region, e.g. a cell. Each cell may be partitioned into multiple sectors as a function of the base station antennas.

The BTSs 220-223 each comprise one or more Transmission/Reception Points (TRPs). For example, each sector within a cell of a BTS may comprise a TRP, although multiple TRPs may share one or more components (e.g., share a processor but have separate antennas). The system 210 may include only macro TRPs or the system 210 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

The UEs 212-214 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, Ultrawideband (UWB), and so on. One or more of a group of the UEs 212-214 utilizing D2D communications may be within a geographic coverage area of a TRP such as one or more of the BTSs 220-223. Other UEs in such a group may be outside such geographic coverage areas, or be otherwise unable to receive transmissions from a base station. Groups of the UEs 212-214 communicating via D2D communications may utilize a one-to-many (1:M) system in which each UE may transmit to other UEs in the group. A TRP of the BTSs 220-223 may facilitate scheduling of resources for D2D communications. In other cases, D2D communications may be carried out between UEs without the involvement of a TRP.

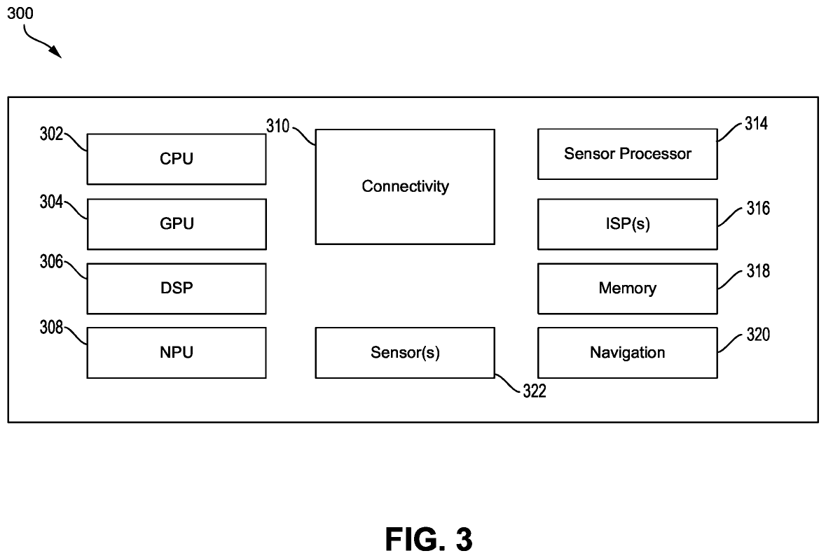

FIG. 3 illustrates an example implementation of a system-on-a-chip (SOC) 300, which may include a central processing unit (CPU) 302 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 308, in a memory block associated with a CPU 302, in a memory block associated with a graphics processing unit (GPU) 304, in a memory block associated with a digital signal processor (DSP) 306, in a memory block 318, and/or may be distributed across multiple blocks. Instructions executed at the CPU 302 may be loaded from a program memory associated with the CPU 302 or may be loaded from a memory block 318.

The SOC 300 may also include additional processing blocks tailored to specific functions, such as a GPU 304, a DSP 306, a connectivity block 310, which may include fifth generation (5G) connectivity, fourth generation long term evolution (4G LTE) connectivity, Wi-Fi connectivity, USB connectivity, Bluetooth connectivity, Ultrawideband (UWB) and the like. In one implementation, the NPU is implemented in the CPU 302, DSP 306, and/or GPU 304. The SOC 300 may also include a sensor processor 314, image signal processors (ISPs) 316, and/or navigation module 320, which may include a global navigation satellite system (GNSS) and/or global positioning system (GPS).

SOC 300 and/or components thereof may be configured to evaluate environmental conditions. For example, the sensor processor 314 may receive and/or process information from one or more sensors 322. Examples of sensors 322 may include one or more Inertial Measurement Units (IMUs) (e.g., an accelerometer, a gyroscope, etc.), temperature sensors, light sensors, shock sensors, humidity sensors, acceleration sensors, speed sensors, tilt angle sensors, etc. sensors of a device. In some cases, the sensors 322 may be located on SOC 300. In other cases, the sensor processor 314 may also be coupled to one or more sensors (not shown) that are external to the SOC 300 (e.g., located on a separate chip). In some cases, the sensor processor 314 may also receive, as input, output of one or more processing blocks of the connectivity block 310.

Moving assets, such as goods, parts, materials, etc., between locations is increasingly an important part of the global economy as supply chains spread out across states, countries, and continents. As moving asserts becomes increasingly important, tracking shipped assets is also becoming to organizations as understanding when assets may arrive and in what condition those assets may be in can be useful for planning operations of the organizations.

To better track and understand environmental conditions asserts may be exposed to as they move, sensor or asset tracking (e.g., tracker) devices may be included with the assets. These trackers may sense the environment around the tracker, gather location information, sense events, and the like. In some cases, the trackers may also periodically report the sensed data. In some cases, trackers may perform non-sensing functionality, such as gathering data from other trackers, command and control operations, such as configuring trackers, scheduling operations of trackers, processing received data, transmitting data, and the like. In some cases, a tracker may include non-sensing functionality in addition to, or instead of the environmental sensing functionality. As the trackers may often be used to track moving assets, the trackers may be relatively low-powered, battery-operated devices. Additionally, trackers often may move in groups with multiple sensors distributed in strategic locations around the assets.

To help enhance battery life of trackers by distributing the activities of the trackers, the trackers may be organized in a network of trackers. The network of trackers may be dynamically formed by nearby trackers without a need for infrastructure support. In some cases, the network of trackers may use any mobile ad hoc network routing protocol, such as on-demand broadcast routing protocols, or routing table-based protocols. Additionally, a network of trackers may be formed across a heterogeneous network of smaller networks of trackers. In some cases, each network of trackers, including sub-networks of trackers, may use a different network routing protocol.

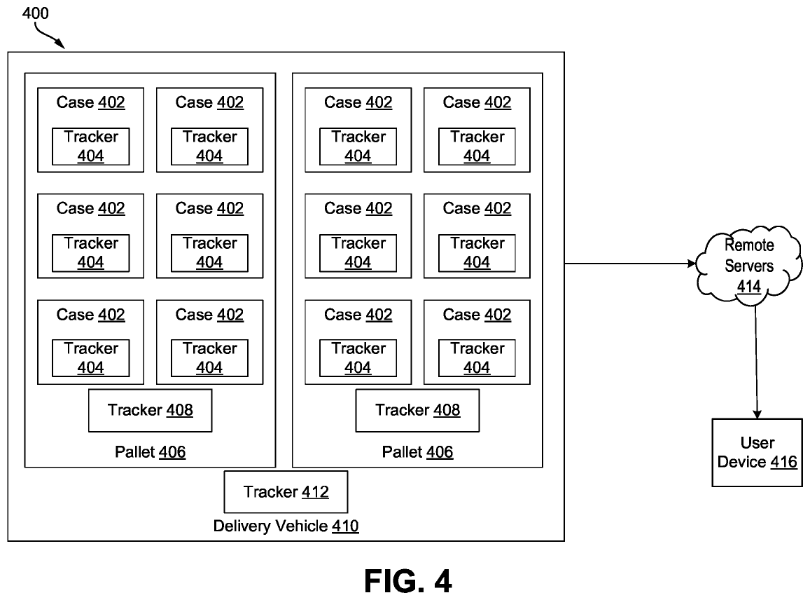

FIG. 4 is a diagram 400 illustrating an example network of trackers on a delivery vehicle 410 (such as delivery vehicle 760 of FIG. 7 shown in the form of a truck, or alternative delivery vehicle 755 of FIG. 7). As shown in diagram 400, assets (such as asset 750 of FIG. 7) may be packed for shipping in one or more boxes or cases 402. In some examples, trackers 404 (e.g., which may include one or more trackers, such as monitoring device 765 of FIG. 7) may be included with the assets in a case 402, or trackers 404 may be distributed in a certain percentage of the cases 402. The trackers 404 distributed in the cases 402 may sense environmental conditions within the cases 402, location of the individual cases 402, distribution of the cases 402, and the like. These cases 402 may be loaded onto pallets 406. In some cases, trackers 408 may be included on a certain percentage of the pallets 406 and these trackers 408 may sense environmental conditions around the cases 402 and/or pallets 406, location of the pallets 406, distribution of the pallets 406, and the like. In some cases, a number of cases 402 per pallet 406 may be known in advance based on a size of the cases 402, carrying capacity of the pallet 406, etc. The pallets 406 may in turn be loaded into a shipping container (e.g., boxcar) on a delivery vehicle 410 (e.g., a truck or other type of vehicle). In some cases, trackers 412 may be included in, for example, the delivery vehicle 410 and these trackers 412 may sense environmental conditions within or around the delivery vehicle 410, location of the delivery vehicle 410, and the like.

In some cases, information gathered from the trackers, such as trackers 404, 408, and 412, may be reported to one or more remote servers 414 (such as network entity 730 of FIG. 7 in the form of a server). The remote servers 414 may process the sensed data and provide the processed data to a user device 416. In some cases, the remote servers 414 may process the sensed data in addition to, or instead of any processing of the data that may be performed by the trackers. In some cases, this processed data may be provided to the user device 416 in near real time and the processed data may be provided continuously, periodically, on a schedule, on-demand, or at any other rate. In some cases, the rate at which data may be provided from the trackers 404 may be adjusted dynamically based on customer demands and hardware capability. As the trackers (e.g., trackers 404, 408, and 412) may be relatively low power devices, there may be a trade-off between sensing and reporting activities with battery life or tracker costs. Additionally, some activities, such as receiving and processing sensing data from other trackers or transmitting data to remote servers 414, may use more battery power than other activities, such as sensing.

In some cases, individual tracker devices may be set up for different roles and different costs. Different tracker hardware may be used based on costs and user needs. For example, for high-value assets, relatively more expensive trackers with more features may be used. As an example of these additional features, the relatively more expensive trackers may offer more granular reporting intervals, less latency, more sensing, and the like as compared to less expensive trackers. As another example, for shipments with a large number of assets with relatively stringent environmental concerns, many lower cost trackers may be distributed throughout the assets. These lower cost trackers may have less features than more expensive trackers, but having more of the lower cost trackers may provide additional samples about conditions experiences across the assets. In some cases, a mixture of trackers may be used.

In diagram 400 includes an example of a mixture of trackers 404, 408, and 412 that may fall in three capability groups. A first group of trackers may be represented by trackers 404. As indicated above, tracker 404 may be used at a case 402 level and may be relatively low cost, with relatively less memory, processing power, and/or battery power as compared to other trackers (e.g., trackers 408 and 412). The trackers 404 may be set up primarily for sensing the environment, with short-range communications to participate in a relatively small network of trackers.

A second group of trackers may be represented by trackers 408. Trackers 408 may be used at a pallet 406 level and may offer more capabilities, with relatively more memory, processing power, and/or battery power as compared to trackers 404, but relatively less memory, processing power, and/or battery power as compared to other trackers (e.g., trackers 412). In some cases, trackers 408 may be relatively more expensive than trackers 404, while less expensive than other trackers, such as tracker 412. Trackers 408 may be set up for additional sensing, data processing, and/or communications to maintain a relatively small network of trackers (e.g., a network of trackers 404 on a pallet) and coordinate with other trackers, such as other trackers 408 and 412.

A third group of trackers may be represented by trackers 412. Trackers 412 (such as monitoring device 765 of FIG. 7) may be used at the delivery vehicle 410 level and may offer more capabilities, with relatively more memory, processing power, and/or battery power as compared to trackers 404 and 408. In some cases, trackers 412 may be tied into a power source for the delivery vehicle 410. Trackers 412 may be set up for data processing, location sensing, and/or enhanced communications capabilities for communicating with, and/or managing, multiple local networks of trackers, associate with additional devices, and communicating with remote servers 414 via a wide area network.

Different networks of trackers may have a variety of different network topologies. In some cases, a single large network of trackers may be defined covering substantially all detectable/useable local trackers. However, such a network may not be the most reliable or easiest to sustain. In some cases, a network including multiple smaller networks of trackers may be used.

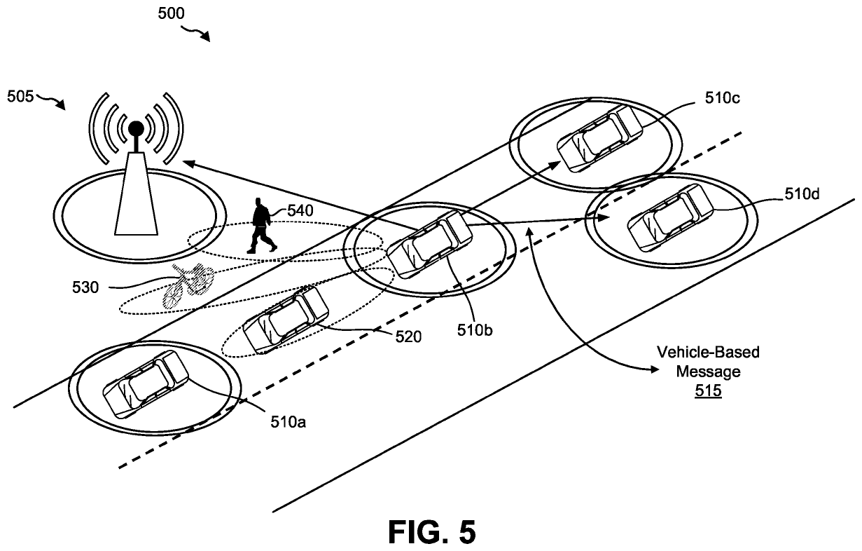

FIG. 5 is a diagram illustrating an example of a system 500 for sensor sharing in V2X (e.g., V2X communications). In FIG. 5, the system 500 is shown to include a plurality of equipped (e.g., V2X capable) devices (e.g., network devices). The plurality of equipped devices includes vehicles 510a, 510b, 510c, 510d (e.g., the vehicles may be automobiles as shown in FIG. 5; trucks, such as delivery vehicle 760 of FIG. 7; alternative delivery vehicle 755 of FIG. 7; etc.), and an RSU 505. Also shown are a plurality of non-equipped devices (e.g., network devices), which include a non-equipped vehicle 520, a vulnerable road user (VRU) 530 in the form of a bicyclist, and a pedestrian 540. The system 500 may comprise more or less equipped devices and/or more or less non-equipped devices, than as shown in FIG. 5. In addition, the system 500 may comprise more or less different types of equipped devices (e.g., which may include equipped UEs, such as device 720 of FIG. 7 in the form of a smart phone) and/or more or less different types of non-equipped devices (e.g., which may include non-equipped UEs) than as shown in FIG. 5. In addition, in one or more examples, the equipped devices may be equipped with heterogeneous capability, which may include, but is not limited to, C-V2X/DSRC capability, 4G/5G cellular connectivity, GPS capability, camera capability, radio frequency-based sensing capability, and/or light-based sensing capability.

The plurality of equipped devices may be capable of performing V2X communications. In addition, at least some of the equipped devices are capable of transmitting and receiving sensing signals for RF sensing signals and/or light-based signals (e.g., optical sensing signals) to detect nearby vehicles and/or objects. In one or more examples, vehicles 510a, 510b, 510c, 510d and RSU 505 may be capable of transmitting and receiving sensing signals of some kind (e.g., RF and/or light-based sensing signals).

In some examples, some of the equipped devices may have higher capability sensors (e.g., GPS receivers, cameras, RF antennas, and/or optical lasers and/or optical sensors) than other equipped devices of the system 500. For example, vehicle 510b may be a luxury vehicle and, as such, have more expensive, higher capability sensors than other vehicles that are economy vehicles. In one illustrative example, vehicle 510b may have one or more higher capability light-based sensors (e.g., high capability optical lasers and optical sensors) than the other equipped devices in the system 500. For instance, the light-based sensor of vehicle 510b may be able to detect a VRU (e.g., cyclist) 530 and/or a pedestrian 540 with a large degree of confidence (e.g., a seventy percent degree of confidence). In another example, vehicle 510b may have higher capability RF sensors (e.g., high capability RF antennas) than the other equipped devices in the system 500. For instance, the RF-based sensor of vehicle 510b may be able to detect the VRU (e.g., cyclist) 530 and/or pedestrian 540 with a degree of confidence (e.g., an eight-five percent degree of confidence).

During operation of the system 500, the equipped devices (e.g., RSU 505 and/or at least one of the vehicles 510a, 510b, 510c, 510d) may transmit and/or receive sensing signals (e.g., RF and/or optical signals) to sense and detect vehicles (e.g., vehicles 510a, 510b, 510c, 510d, and 520) and/or objects (e.g., VRU 530 and pedestrian 540) located within and surrounding the road. The equipped devices (e.g., RSU 505 and/or at least one of the vehicles 510a, 510b, 510c, 510d) may then use the sensing signals to determine characteristics (e.g., motion, dimensions, type, heading, and speed) of the detected vehicles and/or objects. The equipped devices (e.g., RSU 505 and/or at least one of the vehicles 510a, 510b, 510c, 510d) may generate at least one vehicle-based message 515 (e.g., a C-V2X message, such as a Sensor Data Sharing Message (SDSM), a Basic Safety Message (BSM), a Cooperative Awareness Message (CAM), Collective Perception Messages (CPMs), and/or other type of message) including information related to the determined characteristics of the detected vehicles and/or objects.

The vehicle-based message 515 may include information related to the detected vehicle or object (e.g., a position of the vehicle or object, an accuracy of the position, a speed of the vehicle or object, a direction in which the vehicle or object is traveling, and/or other information related to the vehicle or object), traffic conditions (e.g., low speed and/or dense traffic, high speed traffic, information related to an accident, etc.), weather conditions (e.g., rain, snow, etc.), message type (e.g., an emergency message, a non-emergency or “regular” message), etc.), road topology (line-of-sight (LOS) or non-LOS (NLOS), etc.), any combination, thereof, and/or other information. In some examples, the vehicle-based message 515 may also include information regarding the equipped device's preference to receive vehicle-based messages from other certain equipped devices. In some cases, the vehicle-based message 515 may include the current capabilities of the equipped device (e.g., vehicles 510a, 510b, 510c, 510d), such as the equipped device's sensing capabilities (which can affect the equipped device's accuracy in sensing vehicles and/or objects), processing capabilities, the equipped device's thermal status (which can affect the vehicle's ability to process data), and the equipped device's state of health.

In some aspects, the vehicle-based message 515 may include a dynamic neighbor list (also referred to as a Local Dynamic Map (LDM) or a dynamic surrounding map) for each of the equipped devices (e.g., vehicles 510a, 510b, 510c, 510d and RSU 505). For example, each dynamic neighbor list can include a listing of all of the vehicles and/or objects that are located within a specific predetermined distance (or radius of distance) away from a corresponding equipped device. In some cases, each dynamic neighbor list includes a mapping, which may include roads and terrain topology, of all of the vehicles and/or objects that are located within a specific predetermined distance (or radius of distance) away from a corresponding equipped device.

In some implementations, the vehicle-based message 515 may include a specific use case or safety warning, such as a do-not-pass warning (DNPW) or a forward collision warning (FCW), related to the current conditions of the equipped device (e.g., vehicles 510a, 510b, 510c, 510d). In some examples, the vehicle-based message 515 may be in the form of a standard Basic Safety Message (BSM), a Cooperative Awareness Message (CAM), a Collective Perception Message (CPM), a Sensor Data Sharing Message (SDSM) (e.g., SAE J3224 SDSM), and/or other format.

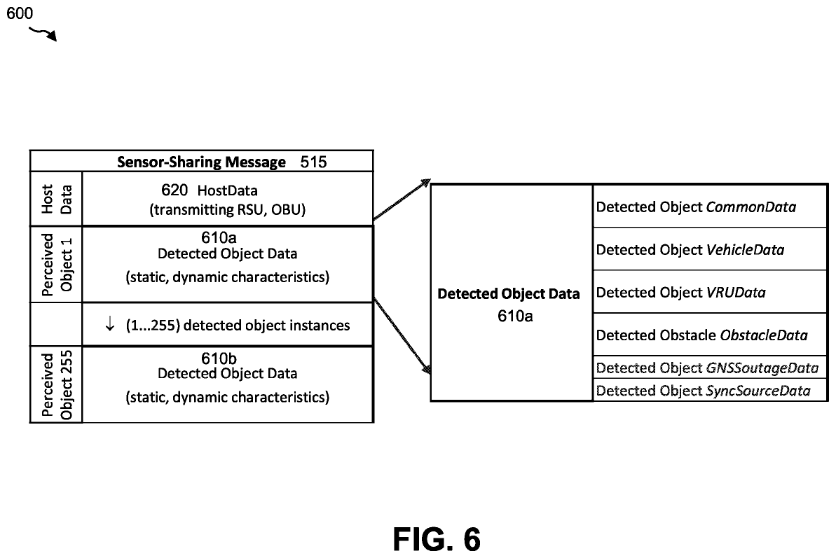

FIG. 6 is a diagram 600 illustrating an example of a vehicle-based message 515. The vehicle-based message 515 is shown as a sensor-sharing message (e.g., an SDSM), but can include a BSM, a CAM, a CPM, or other vehicle-based message as noted herein. In FIG. 6, the vehicle-based message 515 is shown to include HostData 620 and Detected Object Data 610a, 610b. The HostData 620 of the vehicle-based message 515 may include information related to the transmitting device (e.g., such as RSU 505 or an onboard unit (OBU), such as on vehicles 510a, 510b, 510c, 510d) of the vehicle-based message 515. The Detected Object Data 610a, 610b of the vehicle-based message 515 may include information related to the detected vehicle or object (e.g., static or dynamic characteristics related to the detected vehicle or object, and/or other information related to the detected vehicle or object). The Detected Object Data 610a, 610b may specifically include Detected Object CommonData, Detected Object VehicleData, Detected Object VRUData, Detected Obstacle ObstacleData, Detected Object GNSSoutageData, and Detected Object SyncSourceData. These vehicle-based messages 515 are beneficial because they can provide an awareness and understanding to the equipped devices (e.g., vehicles 510a, 510b, 510c, 510d of FIG. 5) of upcoming potential road dangers (e.g., unforeseen oncoming vehicles, accidents, and road conditions).

As previously mentioned, shipping and delivery of assets (e.g., items or goods) is an important activity for many users (e.g., parcel owners), which can be affiliated with various different business organizations. Currently, delivery services (e.g., transport vendors) usually make all the decisions regarding which delivery paths to take for delivery of the assets. The delivery services typically choose the delivery paths to take based on a number of different factors, which may include, but is not limited to, distance, fuel efficiency, etc. However, these chosen delivery paths may not be in the best interest of the users, who may have more specific limitations for their assets.

Certain delivery paths to take for delivery of assets may have some inherent risks (e.g., risks related to theft, volatile climate, high power drain, no charging facilities, etc.). Sometimes, users prefer using these delivery paths over other delivery paths with less inherent risks due factors, which may include lower cost, shorter delivery time, etc. The users may prefer these delivery paths even though these delivery paths can result in harmful consequences occurring to the asset during the delivery of the asset.

In one or more aspects, systems and techniques are provided for risk management and route planning for delivery of assets (e.g., for monitoring devices associated with the assets and/or delivery vehicles). FIG. 7 shows an example of a system 700 for performing route planning for delivery of an asset 750 to a destination location 790. In FIG. 7, a user 710 (e.g., the asset owner), who may be associated (e.g., affiliated) with a business organization, and a device 720 (e.g., which is shown in the form of a smart phone) that may be associated with the user 710 are shown. In one or more examples, the device may be a computing device, such as a smart phone, a tablet, a laptop computer, a desktop computer, etc. In one or more examples, the system 700 may include more than one user 710 (e.g., asset owner), more than one asset 750, and/or more than one destination location 790 than as shown in FIG. 7.

Also shown in FIG. 7 are a network entity 730 (e.g., which may include one or more servers, such as a cloud server), a delivery station 740 (e.g., a building, warehouse, or factory), a storage facility 770 (e.g., a building, warehouse, or factory), and a delivery substation 780 (e.g., a building, warehouse, or factory). The network entity 730, the delivery station 740, the storage facility 770, and/or the delivery substation 780 may be associated with the delivery service (e.g., transport vendor). In one or more examples, the system 700 may include a larger number of network entities 730, delivery stations 740, storage facilities 770, and/or delivery substations 780 than as shown in FIG. 7.

FIG. 7 also shows a delivery vehicle 760 (e.g., shown in the form of a truck) and an alternative delivery vehicle 755. In one or more examples, various different types of delivery vehicles (e.g., car, train, ship, or human deliverer) other than a truck as shown in FIG. 7 may be employed for the delivery vehicle 760, and/or various different types of alternative delivery vehicles (e.g., car, train, truck, ship, or human deliverer) may be employed for the alternative delivery vehicle 755. In one or more examples, the system 700 may include more than one delivery vehicle 760 and/or more than one alternative delivery vehicle 755 than as shown in FIG. 7.

The system 700 of FIG. 7 is also shown to include a monitoring device 765 (e.g., a tracker) associated with the delivery vehicle 760 (e.g., shown in the form of a truck). In one or more examples, the system 700 may include more than one monitoring device 765 than as shown in FIG. 7. For example, more than one monitoring device 765 may be associated with the delivery vehicle 760. In one or more examples, one or more monitoring devices 765 may be associated with the alternative delivery vehicle 755, one or more monitoring devices 765 may be associated with the asset 750, one or more monitoring devices 765 may be associated with the delivery station 740, one or more monitoring devices 765 may be associated with the storage facility 770, and/or one or more monitoring devices 765 may be associated with the delivery substation 780.

In one or more examples, during operation of the system 700, the user 710 may place a delivery order with the delivery service (e.g., transport vendor) for delivery of their associated asset 750 to a destination location 790. The user 710 may place this delivery order by using a device 720 (e.g., a UE, such as a computing device) associated with the user 710. The user 710 may place the delivery order by inputting information (e.g., delivery instructions and a level of service) into their device 720 by using a program (e.g., an application (APP) or a website) associated with the delivery service (e.g., transport vendor) running on the device 720.

When the user 710 is placing their delivery order, the user 710 can select a level of service, which may be a more costly priority level of service or a less expensive basic level of service. In some examples, the user 710 may have previously subscribed to the priority level of service or to the basic level of service for future deliveries of their assets (e.g., such as asset 750) for a predetermined duration of time for the subscription.

After the user 710 has selected or subscribed to a specific level of service, the user 710 can provide a set of delivery criteria (e.g., including their delivery instructions) to the delivery service. An amount of delivery instructions in the set of delivery criteria is based on the level of service associated with the user 710. For example, a set of delivery criteria for a user with a priority level of service can have a larger amount of delivery instructions than a set of delivery criteria for a user with a basic level of service.

In one or more examples, the delivery instructions for a user with the priority level of service may include, but are not limited to, the destination location 760 for the asset 750 to be delivered, a time of delivery for the asset 750 to be delivered to the destination location 790 and/or a delivery path for delivery of the asset 750 to the destination location 790. In some examples, the delivery instructions for a user with the priority level of service may further include, but are not limited to, a level of care of handling (e.g., gentle handling of) the parcel containing the asset 750 during transport, a temperature range for the parcel containing the asset 750, an avoidance of roads with poor driving conditions (e.g., potholes), characteristics of the asset (e.g., flammable, non-flammable, perishable, non-perishable, fragile, and/or not fragile), and/or at least one type of delivery vehicle (e.g., a truck, a car, a train, a ship, a human deliverer, and/or other type of vehicle).

In one or more examples, after the user 710 has inputted the information (e.g., set of delivery criteria including delivery instructions and a level of service) into their device 720, the device 720 can send (e.g., transmit) the information via at least one signal 715 either wirelessly and/or via wire to the network entity 730, which is associated with the delivery service (e.g., transport vendor). After the network entity 730 receives the information, the network entity 730 can gather all of the risk factors that are related to potential delivery paths for delivery of the asset 750 to the specified destination location 790.

In one or more examples, the risk factors that are related to potential delivery paths may include, but are not limited to, a time of delivery (e.g., which may be uncertain) for the asset 750 to arrive at the destination location 790, a delivery path (e.g., which could be a bad road that has poor driving conditions, such as potholes, uneven road surfaces, broken concrete, exposed rebar, sinkholes, and road cracks) for the delivery vehicle 760 (or alternative delivery vehicle 755) to deliver the asset 750 to the destination location 790, environmental information (e.g., wind speed, air flow, storm, cyclone, precipitation, humidity), temperature information (e.g., vehicle temperature information along with package temperature details for the asset 750), battery percentage of a monitoring device associated with the asset, battery percentage of the monitoring device 765 associated with the delivery vehicle 760 carrying the asset 750, delivery substation 780 details, fuel details (e.g., fuel level for the delivery vehicle 750 and/or alternative delivery vehicle 755), charging station details (e.g., electric charging stations for electric delivery vehicles), a change in the delivery path, possible theft of the asset 750, and/or condition of a pallet (e.g., damaged pallet, uneven surface on the pallet, and/or pallet already carrying a heavy weight) holding the asset 750.

In one or more examples, the risk factors that are related to potential delivery paths may be determined by a number of different methods. For example, some risk factors may be determined by use of one or more monitoring devices (such as monitoring device 765). FIG. 4 shows examples of monitoring devices (e.g., trackers) implemented within a delivery vehicle 410 carrying cases 402 of assets on pallets 406. For example, in FIG. 4, tracker 404 is implemented within a case 402 including one or more parcels containing one or more assets (such as asset 750) for delivery, tracker 408 is implemented within pallet 406 containing a plurality of cases 402, and tracker 412 is implemented within the delivery vehicle 410 itself. A monitoring device may collect the risk factor data based on sensed conditions. The monitoring device can sense various different conditions based on the different types of sensors incorporated within the monitoring device. Various different types of sensors may be implemented into the monitoring devices that may include, but are not limited to, visible light sensors (e.g., to detect ambient light), barometric pressure sensors, motion sensors, fuel gauges, humidity sensors, temperature sensors, acoustic sensors, environmental sensors, and/or gas sensors.

In some examples, some of risk factors may be determined by use of sensors incorporated within the delivery vehicle (such as delivery vehicle 760 or alternative delivery vehicle 755) itself and/or other vehicles traveling on or nearby the delivery path. Many vehicles have optical cameras mounted at various different locations on the vehicle. The cameras can capture real images to detect objects and/or obstacles on the road. The images can be used to calculate real time risk factors that can be used to help guide the vehicle or other devices or vehicles nearby. In one or more examples, the vehicles with the sensors may transmit sensor sharing messages (such as vehicle-based message 515 of FIGS. 5 and 6) containing sensor information to other vehicles (e.g., delivery vehicles) and/or to the network entity 730 (e.g., via V2X communications). The coordination of sensor sharing messages can help to improve and manage the risk factors. FIG. 5 shows an example of a vehicle 510b transmitting a vehicle-based message 515 (e.g., containing sensor information sensed by sensors on the vehicle 510b) to another nearby vehicle 510d. The sensor sharing messages (e.g., a vehicle-based message 515) may each be in the form of a standard Basic Safety Message (BSM), a Cooperative Awareness Message (CAM), a Collective Perception Message (CPM), a Sensor Data Sharing Message (SDSM) (e.g., SAE J3224 SDSM), and/or other format.

In one or more examples, the risk factors may be cross-checked (e.g., verified and/or validated) by using information (e.g., other risk factor data, which may be from sensed data from sensors of one or more monitoring devices) from a combination of monitoring devices (e.g., nearby sensing devices, which may be associated with the asset, the case holding the asset, the pallet holding a case holding the asset, and/or the delivery vehicle itself) and/or information (e.g., other risk factor data, which may be from sensed data from sensors) from vehicle sensors (e.g., mounted on various different locations of the delivery vehicle itself or other vehicles traveling nearby the delivery vehicle and/or traveling on at least a portion of the delivery path 745). In one or more examples, the network entity 730 (e.g., a server, such as a cloud server) can cross-check (e.g., verify and/or validate) the risk factors, and tag the risk factors accordingly (e.g., whether the risk factors have been verified or not) based on the results of the cross-checking.

After the network entity 730 has gathered all of the risk factors that are related to potential delivery paths for delivery of the asset 750 to the destination location 790, the network entity 730 may then perform delivery planning to determine delivery planning information for delivery of the asset 750 to the destination location 790. The delivery planning information may include the delivery path 745 to use and the time of delivery of the asset 750 to the destination location 790. The delivery planning information may additionally include a level of care of handling of the asset 750 during transport, a temperature range of the asset 750 during transport, at least one type of delivery vehicle (such as delivery vehicle 760 in the form of a truck), and/or a use of one or more alternative delivery vehicles (such as alternative delivery vehicle 755). In one or more examples, for the delivery planning, the network entity 730 can determine to segregate (or conversely combine) parcels (e.g., containing assets, such as asset 750) according to the associated risk factors and, optionally, cost factors related to the different delivery paths for the assets. In some examples, pallets of multiple delivery services (e.g., transport vendors) can be combined together to be transported by a single delivery service (e.g., transport vendor).

The network entity 730 can determine the delivery planning information by using (e.g., based on) received sets of delivery criteria (e.g., including delivery instructions) from a plurality of users (e.g., including the received set of delivery criteria from the user 710) to deliver their assets (e.g., including asset 750); optionally, the risk factors related to different potential delivery paths for the assets (e.g., including asset 750); and optionally, the levels of service of the users (e.g., including user 710). After the network entity 730 has performed the delivery planning for delivery of the asset 750 to the destination location 790, the network entity 730 can send (e.g., transmit) one or more signals 725 (e.g., via the internet 735) including the delivery planning information to the delivery station 740, which may be storing the asset 750. After the delivery station 740 receives the delivery planning information, according to the delivery planning information, the asset 750 may be moved onto a specific delivery vehicle 760 for delivery to the destination location 790. After the asset 750 is moved onto the delivery vehicle 760, the delivery vehicle 760 can follow the specific delivery path 745 indicated within the delivery planning information.

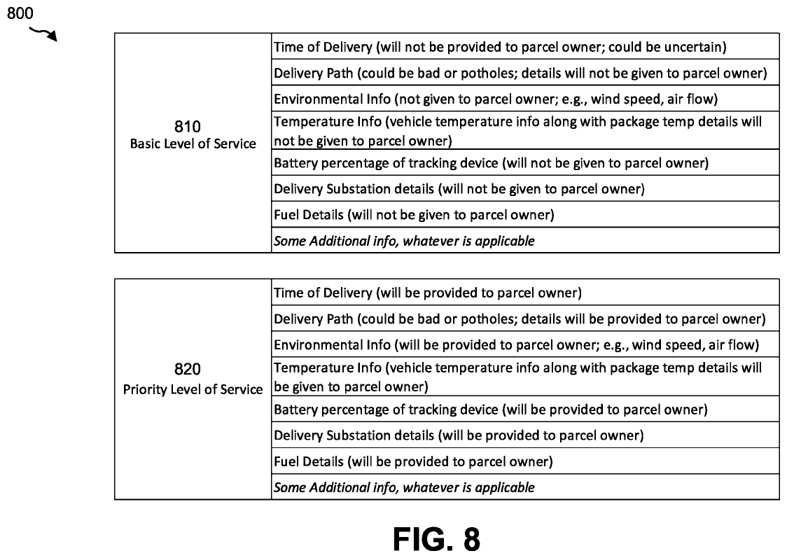

After the network entity 730 has performed the delivery planning for delivery of the asset 750 to the destination location 790, the network entity 730 can also send (e.g., transmit) one or more delivery notifications (e.g., including delivery information) regarding the delivery of the asset 750 to the device 720 associated with the user 710 via one or more signals 775. The one or more delivery notifications may be sent before, during, and/or after the delivery of the asset 745 to the destination location 790. Delivery notifications sent to users with the priority level of service may include more delivery information than the delivery notifications sent to users with a basic level of service. In one or more examples, delivery notifications sent to users with a priority level of service may include delivery information that may include, but is not limited to, the time of delivery of the asset 750 to the destination location 790 and the delivery path 745. In some examples, delivery notifications sent to users with a priority level of service may include delivery information that may further include, but is not limited to, environmental information, temperature information related to the asset 750, a battery percentage of an associated monitoring device (such as monitoring device 765), delivery substation (such as delivery substation 780) details, fuel details for the delivery vehicle (such as delivery vehicle 760 or alternative delivery vehicle 765), a type of delivery vehicle, and/or a change in the delivery path (e.g., a change where delivery path 745 is no longer being used). The description of FIG. 8 describes further details regarding the delivery notifications.

In one or more examples, during the delivery, one or more monitoring devices (such as monitoring device 765) associated with the asset 750 may continue to collect risk factor data for the risk factors that are related to the currently chosen delivery path 745 for the asset 750. As previously mentioned, FIG. 4 shows examples of monitoring devices (e.g., trackers) implemented within a delivery vehicle 410 carrying cases 402 of assets on pallets 406. During the delivery of the asset 750, one or more monitoring devices (e.g., monitoring device 765 and/or trackers 404, 408, 412) may collect risk factor data based on sensed conditions sensed by the sensors of the one or more monitoring devices. After the one or more monitoring devices have collected the risk factor data, the delivery vehicle 765 (equipped with the sensors) may transmit sensor sharing messages (e.g., vehicle-based message 515 of FIGS. 5 and 6) containing sensor information to other vehicles (e.g., delivery vehicles) and/or to the network entity 730, such as via V2X communications. After the network entity 730 has received the risk factors that are related to the current delivery path 745 for delivery of the asset 750 to the destination location 790, the network entity 730 may then consolidate all of its gathered risk factor data (including the risk factor data obtained prior to the start of the delivery and the risk factor data obtained during the delivery) to perform delivery planning (based on the gathered risk factor data, the delivery instructions, and the level of service of the user 710) to determine delivery information (e.g., which may include an alternative option for the delivery, such as an alternative delivery path and/or delivery vehicle) for delivery of the asset 750 to the destination location 790.

In one or more examples, the network entity 730 may send (e.g., transmit), during the delivery, to the user 710, one or more signals including delivery information, which may include an alternative option (e.g., an option for dynamically changing the current delivery vehicle to an alternative delivery vehicle, such as alternative delivery vehicle 755, and/or an option for dynamically adjusting the current delivery path to an alternative delivery path, such as a path other than delivery path 745), when there is a sudden change (e.g., environmental impact, bad road infrastructure, etc.) in the current delivery path 745. In one or more examples, the user 710 (e.g., when the user 710 has the priority level of service) can reject (e.g., cancel) the delivery of the asset 750, when the delivery performance does not strictly follow the delivery instructions from the user 710. In these examples, the delivery service (e.g., transport vendor) can identify one or more storage facilities (such as storage facility 770) where the assets (such as asset 750) of the rejected deliveries can be stored. In one or more example, when the delivery service (e.g., delivery vendor) does not strictly follow the delivery instructions from the user 710 and/or when the user 710 has rejected (e.g., canceled) delivery of the asset 750, the delivery service may issue a partial or full refund of the delivery fee back to the user 710.

In one or more examples, insurance companies can charge different rates for different delivery paths, and the delivery path information can be shared with the insurance companies. In some examples, different premiums may be charged by the insurance companies for different delivery paths (e.g., even for the same destination location for the parcel) and/or for different damage claims for different paths. In one or more examples, insurance companies can implement a tariff plan based on the different risk factors associated with the different delivery paths. Insurance companies can use the different risk factors for the different delivery paths to determine insurance premiums and/or claim amounts for a particular delivery of an asset.

FIG. 8 is a table 800 illustrating example risk factors (e.g., related to the successful delivery of an asset) that may be notified (or not notified) to users (such as user 710 of FIG. 7) with different levels of service (such as a basic level of service 810 and a priority level of service 820). The different levels of service are related to the delivery of one or more assets (such as asset 750 of FIG. 7) to a destination location (such as destination location 790 of FIG. 7), as specified by the user. In particular, in FIG. 8, the table 800 shows various different risk factors (e.g., which may be included in delivery information of delivery notifications) that may or may not be notified to users via the delivery notifications.

In one or more aspects, the amount of delivery information (e.g., amount of risk factors) in each of the delivery notifications to a user can be based on the level of service (e.g., the basic level of service 810 or the priority level of service 820) associated with the user. In one or more examples, a delivery notification for a user having the priority level of service 820 may include more delivery information (e.g., include a larger number of risk factors) than a delivery notification for a user having the basic level of service 810.

In one or more aspects, when the user has the basic level of service 810, the user may not be notified of different risk factors, which may include, but are not limited to, a time of delivery (e.g., which may be uncertain) for the asset to arrive at the destination location, a delivery path (e.g., which could be a bad road that has poor driving conditions, such as potholes) for the delivery vehicle (such as delivery vehicle 760 of FIG. 7 or alternative delivery vehicle 755 of FIG. 7) to deliver the asset to the destination location, environmental information (e.g., wind speed, air flow, precipitation, humidity), temperature information (e.g., vehicle temperature information along with package temperature details for the asset), battery percentage of a monitoring device (such as monitoring device 765 of FIG. 7) associated with the asset and/or the delivery vehicle, delivery substation (such as substation 780 of FIG. 7) details, fuel details (e.g., fuel level for the delivery vehicle), a change in the delivery path, and/or some other additional information. When the user is not notified of any risk factors at all, the user may not receive any delivery notifications. However, in some examples, when the user has the basic level of service 810, the user may be notified (e.g., via a delivery notification) of an estimated time of delivery of the asset to the destination location and/or may be notified of other additional information.

In one or more aspects, when the user has the priority level of service 820, the user may receive delivery notifications (e.g., from a network entity such as network entity 730 of FIG. 7 in the form of a server) including delivery information related to different risk factors. These different risk factors may include, but are not limited to, the time of delivery for the asset to arrive at the destination location and the delivery path (e.g., which could be a bad road that has poor driving conditions, such as potholes) for the delivery vehicle (such as delivery vehicle 760 of FIG. 7 or alternative delivery vehicle 755 of FIG. 7) to deliver the asset to the destination location. In some aspects, when the user has the priority level of service 820, the user may receive delivery notifications (e.g., from a network entity such as network entity 730 of FIG. 7 in the form of a server) that include additional delivery information related to risk factors, which may include, but are not limited to, the environmental information (e.g., wind speed, air flow, precipitation, humidity), the temperature information (e.g., vehicle temperature information along with package temperature details for the asset), the battery percentage of a monitoring device (such as monitoring device 765 of FIG. 7) associated with the asset and/or the delivery vehicle, the delivery substation (such as substation 780 of FIG. 7) details, the fuel details (e.g., the fuel level for the delivery vehicle), a change in the delivery path, and/or some other additional information (such as a type of delivery vehicle).

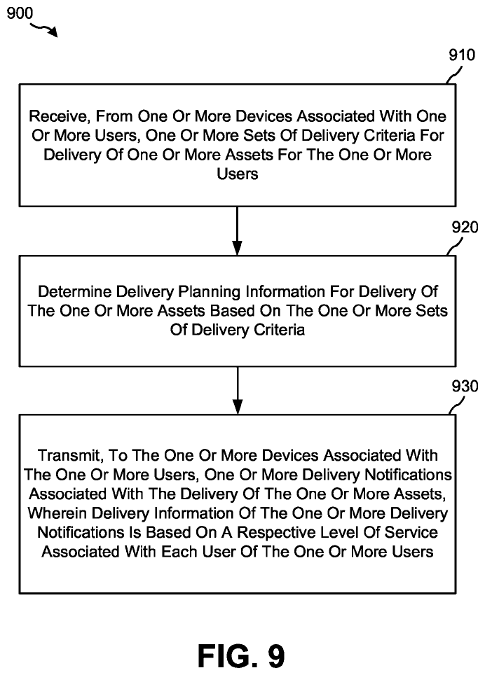

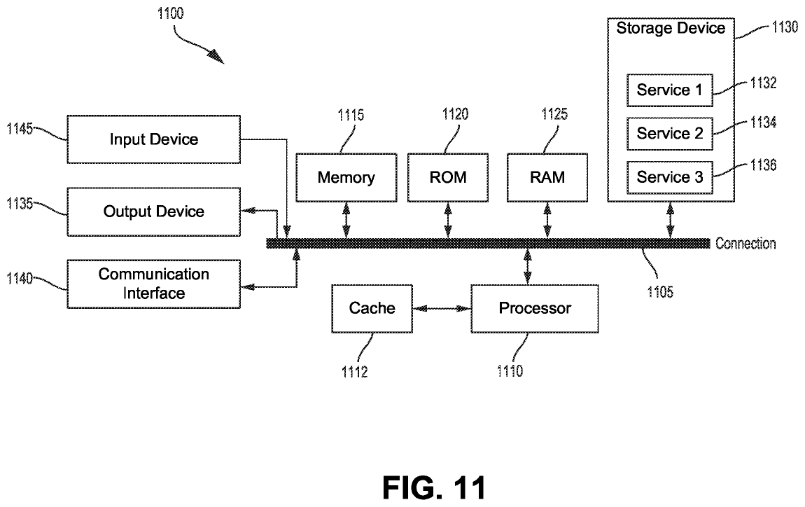

FIG. 9 is a flow chart illustrating an example of a process 900 for wireless communications utilizing methods for risk management and route planning for IoT devices, such as monitoring devices. The process 900 can be performed by a network entity (e.g., network entity 730 of FIG. 7 in the form of a server) or by a component or system (e.g., a chipset) of the network entity. The operations of the process 900 may be implemented as software components that are executed and run on one or more processors (e.g., processor 1110 of FIG. 11 or other processor(s)). Further, the transmission and reception of signals by the device (e.g., device 720 of FIG. 7 in the form of a smart phone) in the process 900 may be enabled, for example, by one or more antennas and/or one or more transceivers (e.g., wireless transceiver(s)).

At block 910, the network entity (or component thereof) can receive, from one or more devices associated with one or more users (e.g., device 720 associated with user 710), one or more sets of delivery criteria (e.g., the information including the set of delivery criteria transmitted from device 720 via signal 715 of FIG. 7) for delivery of one or more assets (e.g., assets shown in FIG. 4, asset 750 of FIG. 7, etc.) for the one or more users. Each of the one or more sets of delivery criteria includes delivery instructions for each user of the one or more users. In some examples, each asset of the one or more assets is one of a perishable asset or a non-perishable asset.

In some aspects, an amount of the delivery instructions for each of the one or more sets of delivery criteria can be based on a respective level of service associated with each user of the one or more users. For example, the respective level of service associated with each user of the one or more users can include a basic level of service or a priority level of service (e.g., the basic level of service 810 and the priority level of service 820 of FIG. 8). In some cases, a set of delivery criteria of the one or more sets of delivery criteria for a user of the one or more users with the priority level of service can include a higher amount of delivery instructions for the user than a set of delivery criteria of the one or more sets of delivery criteria for a user of the one or more users with the basic level of service. For example, the delivery instructions for the user with the priority level of service include a destination location, a time of delivery, and a delivery path. Additionally or alternatively, the delivery instructions for the user with the priority level of service can include a level of care of handling during transport, a temperature range during the transport, an avoidance of roads with poor driving conditions, asset characteristics, at least one type of delivery vehicle, any combination thereof, and/or other delivery instructions. The at least one type of delivery vehicle can include a truck, a car, a train, a ship, a human deliverer, any combination thereof, and/or other type of delivery vehicle.

At block 920, the network entity (or component thereof) can determine delivery planning information for delivery of the one or more assets based on the one or more sets of delivery criteria. In some aspects, the network entity (or component thereof) can determine the delivery planning information for delivery of the one or more assets further based on one or more risk factors associated with potential delivery paths for delivery of the one or more assets. For instance, as discussed with respect to FIG. 7, once risk factors that are related to potential delivery paths for delivery of the asset 750 to the destination location 790 are obtained, the network entity 730 may perform delivery planning to determine delivery planning information for delivery of the asset 750 to the destination location 790. In some cases, one or more tariffs, one or more insurance premiums, and/or one or more claim amounts are based on the one or more risk factors associated with the potential delivery paths for delivery of the one or more assets. In some examples, the network entity (or component thereof) can verify the one or more risk factors based on comparing the one or more risk factors with other risk factor data obtained by sensing devices. In some cases, the network entity (or component thereof) can determine at least one of one or more alternative delivery paths or one or more alternative delivery vehicles based on risk factor data obtained from sensed conditions sensed during delivery (e.g., sensed by one or more sensors of a monitoring device, such as visible light sensors (e.g., to detect ambient light), barometric pressure sensors, motion sensors, fuel gauges, humidity sensors, temperature sensors, acoustic sensors, environmental sensors, gas sensors, any combination thereof, and/or other sensors).

In some aspects, the network entity (or component thereof) can determine the delivery planning information for delivery of the one or more assets based on the respective level of service associated with each user of the one or more users. In some cases, to determine the delivery planning information for delivery of the one or more assets, the network entity (or component thereof) can determine a delivery path and a time of delivery for each of the one or more assets. Additionally or alternatively, in some examples, to determine the delivery planning information for delivery of the one or more assets, the network entity (or component thereof) can determine, for each of the one or more assets, a level of care of handling during transport, a temperature range during the transport, at least one type of delivery vehicle, a use of one or more alternative delivery vehicles, any combination thereof, and/or other planning information. Additionally or alternatively, in some cases, to determine the delivery planning information for delivery of the one or more assets, the network entity (or component thereof) can determine one or more storage facilities located along the delivery path for each of the one or more assets.

At block 930, the network entity (or component thereof) can transmit, to the one or more devices associated with the one or more users, one or more delivery notifications associated with the delivery of the one or more assets. For instance, referring again to FIG. 7 as an illustrative example, once the network entity 730 has performed the delivery planning for delivery of the asset 750 to the destination location 790, the network entity 730 can transmit one or more delivery notifications (e.g., including delivery information) regarding the delivery of the asset 750 to the device 720 associated with the user 710 via one or more signals 775.

Delivery information of the one or more delivery notifications is based on the respective level of service (e.g., the basic level of service, the priority level of service, etc.) associated with each user of the one or more users. For instance, an amount of the delivery information in each of the one or more delivery notifications can be based on the respective level of service associated with each user of the one or more users. In some cases, a delivery notification of the one or more delivery notifications for a user of the one or more users with the priority level of service includes a higher amount of the delivery information than a delivery notification of the one or more delivery notifications for a user of the one or more users with the basic level of service. For instance, delivery notifications sent to users with the priority level of service may include more delivery information than the delivery notifications sent to users with a basic level of service. In one example, the delivery information for the user with the priority level of service includes a time of delivery and a delivery path (e.g., the time of delivery of the asset 750 to the destination location 790 and the delivery path 745 of FIG. 7). Additionally or alternatively, the delivery information for the user with the priority level of service further can include environmental information, temperature information, battery percentage of an associated monitoring device, delivery substation details, fuel details, a type of delivery vehicle, a change in the delivery path, any combination thereof, and/or other delivery information. In some cases, the network entity (or component thereof) can dynamically adjust during transport the delivery path for at least one of the one or more assets (e.g., dynamically adjust a current delivery path to an alternative delivery path, such as a path other than delivery path 745 of FIG. 7) or dynamically adjust to another alternative option (e.g., an option for dynamically changing the current delivery vehicle to an alternative delivery vehicle, such as alternative delivery vehicle 755 of FIG. 7).

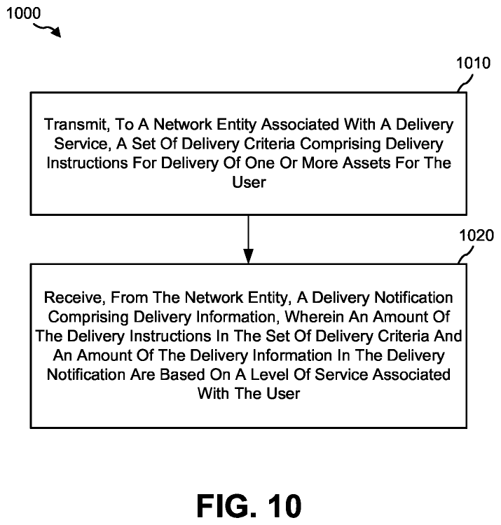

FIG. 10 is a flow chart illustrating an example of a process 1000 for wireless communications utilizing methods for risk management and route planning for IoT devices, such as monitoring devices. The process 1000 can be performed by a device of a user (e.g., device 720 of a user 710 of FIG. 7 in the form of a smart phone) or by a component or system (e.g., a chipset) of the device. The operations of the process 1000 may be implemented as software components that are executed and run on one or more processors (e.g., processor 1110 of FIG. 11 or other processor(s)). Further, the transmission and reception of signals by the device in the process 1000 may be enabled, for example, by one or more antennas and/or one or more transceivers (e.g., wireless transceiver(s)).

At block 1010, the device (or component thereof) can transmit, to a network entity (e.g., network entity 730 of FIG. 7) associated with a delivery service, a set of delivery criteria including delivery instructions (e.g., the information including the set of delivery criteria transmitted from device 720 via signal 715 of FIG. 7) for delivery of one or more assets (e.g., assets shown in FIG. 4, asset 750 of FIG. 7, etc.) for the user. In some cases, an amount of the delivery instructions in the set of delivery criteria is based on a level of service associated with the user. In some aspects, the level of service associated with the user is one of a basic level of service or a priority level of service (e.g., the basic level of service 810 and the priority level of service 820 of FIG. 8). In some cases, the priority level of service is associated with a higher amount of the delivery instructions than an amount of the delivery instructions associated with the basic level of service. For example, the delivery instructions for the user with the priority level of service can include a destination location, a time of delivery, and a delivery path. Additionally or alternatively, the delivery instructions for the user with the priority level of service further includes a level of care of handling during transport, a temperature range during the transport, an avoidance of roads with poor driving conditions, asset characteristics, at least one type of delivery vehicle, any combination thereof, and/or other delivery instructions. For instance, the one at least one type of delivery vehicle can include a truck, a car, a train, a ship, a human deliverer, any combination thereof, and/or other type of delivery vehicle.

At block 1020, the device (or component thereof) can receive, from the network entity, a delivery notification including delivery information. For instance, referring to FIG. 7 as an illustrative example, the device 720 can receive from the network entity 730 one or more delivery notifications (e.g., including delivery information) regarding the delivery of the asset 750 via one or more signals 775. An amount of the delivery information in the delivery notification is based on the level of service associated with the user. In some cases, the priority level of service is associated with a higher amount of the delivery information in the delivery notification than an amount of delivery information for a delivery notification associated with the basic level of service. For example, the delivery information for the user with the priority level of service includes a time of delivery and a delivery path (e.g., the time of delivery of the asset 750 to the destination location 790 and the delivery path 745 of FIG. 7). Additionally or alternatively, the delivery information for the user with the priority level of service can include environmental information, temperature information, battery percentage of an associated monitoring device, delivery substation details, fuel details, a type of delivery vehicle, a change in the delivery path, any combination thereof, and/or other delivery information.

The network entity and/or the device may include various components, such as one or more input devices, one or more output devices, one or more processors, one or more microprocessors, one or more microcomputers, one or more cameras, one or more sensors, one or more receivers, transmitters, and/or transceivers, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the network entity configured to perform the process 900 of FIG. 9 and/or the components of the device configured to perform the process 1000 of FIG. 10 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 900 and the process 1000 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 900, the process 1000, and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 11 is a block diagram illustrating an example of a computing system 1100, which may be employed by the disclosed systems and techniques for risk management and route planning for IoT devices, such as monitoring devices (e.g., trackers). In particular, FIG. 11 illustrates an example of computing system 1100, which can be, for example, any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some aspects, computing system 1100 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1100 includes at least one processing unit (CPU or processor) 1110 and connection 1105 that communicatively couples various system components including system memory 1115, such as read-only memory (ROM) 1120 and random access memory (RAM) 1125 to processor 1110. Computing system 1100 can include a cache 1112 of high-speed memory connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms. In some instances, multimodal systems can enable a user to provide multiple types of input/output to communicate with computing system 1100.

Computing system 1100 can include communications interface 1140, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1140 may also include one or more range sensors (e.g., light-based sensors, laser range finders, RF-based sensors, ultrasonic sensors, and infrared (IR) sensors) configured to collect data and provide measurements to processor 1110, whereby processor 1110 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some aspects, a hardware service that performs a particular function can include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative aspects of the disclosure include:

Aspect 1. A network entity associated with a delivery service, the network entity comprising: at least one memory; and at least one processor coupled to the at least one memory and configured to: receive, from one or more devices associated with one or more users, one or more sets of delivery criteria for delivery of one or more assets for the one or more users; determine delivery planning information for delivery of the one or more assets based on the one or more sets of delivery criteria; and transmit, to the one or more devices associated with the one or more users, one or more delivery notifications associated with the delivery of the one or more assets, wherein delivery information of the one or more delivery notifications is based on a respective level of service associated with each user of the one or more users.

Aspect 2. The network entity of Aspect 1, wherein each of the one or more sets of delivery criteria comprises delivery instructions for each user of the one or more users, and wherein an amount of the delivery instructions for each of the one or more sets of delivery criteria is based on the respective level of service associated with each user of the one or more users.

Aspect 3. The network entity of Aspect 2, wherein the respective level of service associated with each user of the one or more users is one of a basic level of service or a priority level of service.

Aspect 4. The network entity of Aspect 3, wherein a set of delivery criteria of the one or more sets of delivery criteria for a user of the one or more users with the priority level of service comprise a higher amount of delivery instructions for the user than a set of delivery criteria of the one or more sets of delivery criteria for a user of the one or more users with the basic level of service.

Aspect 5. The network entity of any one of Aspects 3 or 4, wherein the delivery instructions for the user with the priority level of service comprise a destination location, a time of delivery, and a delivery path.

Aspect 6. The network entity of Aspect 5, wherein the delivery instructions for the user with the priority level of service further comprises at least one of a level of care of handling during transport, a temperature range during the transport, an avoidance of roads with poor driving conditions, asset characteristics, or at least one type of delivery vehicle.

Aspect 7. The network entity of Aspect 6, wherein the one at least one type of delivery vehicle comprises at least one of a truck, a car, a train, a ship, or a human deliverer.

Aspect 8. The network entity of any one of Aspects 1 to 7, wherein an amount of the delivery information in each of the one or more delivery notifications is based on the respective level of service associated with each user of the one or more users.

Aspect 9. The network entity of Aspect 8, wherein the respective level of service associated with each user of the one or more users is one of a basic level of service or a priority level of service.

Aspect 10. The network entity of Aspect 9, wherein a delivery notification of the one or more delivery notifications for a user of the one or more users with the priority level of service comprises a higher amount of the delivery information than a delivery notification of the one or more delivery notifications for a user of the one or more users with the basic level of service.

Aspect 11. The network entity of Aspect 10, wherein the delivery information for the user with the priority level of service comprises a time of delivery and a delivery path.

Aspect 12. The network entity of Aspect 11, wherein the delivery information for the user with the priority level of service further comprises at least one of environmental information, temperature information, battery percentage of an associated monitoring device, delivery substation details, fuel details, a type of delivery vehicle, or a change in the delivery path.

Aspect 13. The network entity of any one of Aspects 1 to 12, wherein the at least one processor is configured to determine the delivery planning information for delivery of the one or more assets based on the respective level of service associated with each user of the one or more users.

Aspect 14. The network entity of any one of Aspects 1 to 13, wherein, to determine the delivery planning information for delivery of the one or more assets, the at least one processor is configured to determine a delivery path and a time of delivery for each of the one or more assets.

Aspect 15. The network entity of Aspect 14, wherein, to determine the delivery planning information for delivery of the one or more assets, the at least one processor is configured to determine, for each of the one or more assets, at least one of a level of care of handling during transport, a temperature range during the transport, at least one type of delivery vehicle, or a use of one or more alternative delivery vehicles.

Aspect 16. The network entity of any one of Aspects 14 or 15, wherein, to determine the delivery planning information for delivery of the one or more assets, the at least one processor is configured to determine one or more storage facilities located along the delivery path for each of the one or more assets.

Aspect 17. The network entity of any one of Aspects 14 to 16, wherein the at least one processor is configured to dynamically adjust during transport the delivery path for at least one of the one or more assets.

Aspect 18. The network entity of any one of Aspects 1 to 17, wherein each asset of the one or more assets is one of a perishable asset or a non-perishable asset.

Aspect 19. The network entity of any one of Aspects 1 to 17, wherein the at least one processor is configured to determine the delivery planning information for delivery of the one or more assets further based on one or more risk factors associated with potential delivery paths for delivery of the one or more assets.

Aspect 20. The network entity of Aspect 19, wherein at least one of one or more tariffs, one or more insurance premiums, or one or more claim amounts are based on the one or more risk factors associated with the potential delivery paths for delivery of the one or more assets.

Aspect 21. The network entity of any one of Aspects 19 or 20, wherein at least one processor is configured to verify the one or more risk factors based on comparing the one or more risk factors with other risk factor data obtained by sensing devices.

Aspect 22. The network entity of any one of Aspects 1 to 21, wherein at least one processor is configured to determine at least one of one or more alternative delivery paths or one or more alternative delivery vehicles based on risk factor data obtained from sensed conditions sensed during delivery.

Aspect 23. A device associated with a user for wireless communications, the device comprising: at least one memory; and at least one processor coupled to the at least one memory and configured to: transmit, to a network entity associated with a delivery service, a set of delivery criteria comprising delivery instructions for delivery of one or more assets for the user; and receive, from the network entity, a delivery notification comprising delivery information, wherein an amount of the delivery information in the delivery notification is based on a level of service associated with the user.

Aspect 24. The device of Aspect 23, wherein an amount of the delivery instructions in the set of delivery criteria is based on the level of service associated with the user.

Aspect 25. The device of any one of Aspects 23 or 24, wherein the level of service associated with the user is one of a basic level of service or a priority level of service.

Aspect 26. The device of Aspect 25, wherein the priority level of service is associated with a higher amount of the delivery instructions than an amount of the delivery instructions associated with the basic level of service.

Aspect 27. The device of Aspect 26, wherein the delivery instructions for the user with the priority level of service comprise a destination location, a time of delivery, and a delivery path.

Aspect 28. The device of Aspect 27, wherein the delivery instructions for the user with the priority level of service further comprises at least one of a level of care of handling during transport, a temperature range during the transport, an avoidance of roads with poor driving conditions, asset characteristics, or at least one type of delivery vehicle.

Aspect 29. The device of Aspect 28, wherein the one at least one type of delivery vehicle comprises at least one of a truck, a car, a train, a ship, or a human deliverer.

Aspect 30. The device of any one of Aspects 25 to 29, wherein the priority level of service is associated with a higher amount of the delivery information in the delivery notification than an amount of delivery information for a delivery notification associated with the basic level of service.

Aspect 31. The device of Aspect 30, wherein the delivery information for the user with the priority level of service comprises a time of delivery and a delivery path.

Aspect 32. The device of Aspect 31, wherein the delivery information for the user with the priority level of service further comprises at least one of environmental information, temperature information, battery percentage of an associated monitoring device, delivery substation details, fuel details, a type of delivery vehicle, or a change in the delivery path.

Aspect 33. A method for wireless communications at a network entity associated with a delivery service, the method comprising: receiving, by the network entity from one or more devices associated with one or more users, one or more sets of delivery criteria for delivery of one or more assets for the one or more users; determining, by the network entity, delivery planning information for delivery of the one or more assets based on the one or more sets of delivery criteria; and transmitting, by the network entity to the one or more devices associated with the one or more users, one or more delivery notifications associated with the delivery of the one or more assets, wherein delivery information of the one or more delivery notifications is based on a respective level of service associated with each user of the one or more users.

Aspect 34. The method of Aspect 33, wherein each of the one or more sets of delivery criteria comprises delivery instructions for each user of the one or more users, and wherein an amount of the delivery instructions for each of the one or more sets of delivery criteria is based on the respective level of service associated with each user of the one or more users.

Aspect 35. The method of Aspect 34, wherein the respective level of service associated with each user of the one or more users is one of a basic level of service or a priority level of service.

Aspect 36. The method of Aspect 35, wherein a set of delivery criteria of the one or more sets of delivery criteria for a user of the one or more users with the priority level of service comprise a higher amount of delivery instructions for the user than a set of delivery criteria of the one or more sets of delivery criteria for a user of the one or more users with the basic level of service.

Aspect 37. The method of any one of Aspects 35 or 36, wherein the delivery instructions for the user with the priority level of service comprise a destination location, a time of delivery, and a delivery path.

Aspect 38. The method of Aspect 37, wherein the delivery instructions for the user with the priority level of service further comprises at least one of a level of care of handling during transport, a temperature range during the transport, an avoidance of roads with poor driving conditions, asset characteristics, or at least one type of delivery vehicle.

Aspect 39. The method of Aspect 38, wherein the one at least one type of delivery vehicle comprises at least one of a truck, a car, a train, a ship, or a human deliverer.

Aspect 40. The method of any one of Aspects 33 to 39, wherein an amount of the delivery information in each of the one or more delivery notifications is based on the respective level of service associated with each user of the one or more users.

Aspect 41. The method of Aspect 40, wherein the respective level of service associated with each user of the one or more users is one of a basic level of service or a priority level of service.

Aspect 42. The method of Aspect 41, wherein a delivery notification of the one or more delivery notifications for a user of the one or more users with the priority level of service comprises a higher amount of the delivery information than a delivery notification of the one or more delivery notifications for a user of the one or more users with the basic level of service.

Aspect 43. The method of Aspect 42, wherein the delivery information for the user with the priority level of service comprises a time of delivery and a delivery path.

Aspect 44. The method of Aspect 43, wherein the delivery information for the user with the priority level of service further comprises at least one of environmental information, temperature information, battery percentage of an associated monitoring device, delivery substation details, fuel details, a type of delivery vehicle, or a change in the delivery path.

Aspect 45. The method of any one of Aspects 33 to 44, wherein determining the delivery planning information for delivery of the one or more assets is further based on the respective level of service associated with each user of the one or more users.

Aspect 46. The method of any one of Aspects 33 to 45, wherein determining the delivery planning information for delivery of the one or more assets comprises determining a delivery path and a time of delivery for each of the one or more assets.

Aspect 47. The method of Aspect 46, wherein determining the delivery planning information for delivery of the one or more assets further comprises determining, for each of the one or more assets, at least one of a level of care of handling during transport, a temperature range during the transport, at least one type of delivery vehicle, or a use of one or more alternative delivery vehicles.

Aspect 48. The method of any one of Aspects 46 or 47, wherein determining the delivery planning information for delivery of the one or more assets further comprises determining one or more storage facilities located along the delivery path for each of the one or more assets.

Aspect 49. The method of any one of Aspects 46 to 48, further comprising dynamically adjusting during transport, by the network entity, the delivery path for at least one of the one or more assets.

Aspect 50. The method of any one of Aspects 33 to 49, wherein the one or more assets are each one of a perishable assets or a non-perishable assets.

Aspect 51. The method of any one of Aspects 33 to 50, wherein determining the delivery planning information for delivery of the one or more assets is further based on one or more risk factors associated with potential delivery paths for delivery of the one or more assets.

Aspect 52. The method of Aspect 51, wherein at least one of one or more tariffs, one or more insurance premiums, or one or more claim amounts are based on the one or more risk factors associated with the potential delivery paths for delivery of the one or more assets.

Aspect 53. The method of any one of Aspects 51 or 52, further comprising verifying the one or more risk factors by comparing the one or more risk factors with other risk factor data obtained by sensing devices.

Aspect 54. The method of any one of Aspects 33 to 53, further comprising determining at least one of one or more alternative delivery paths or one or more alternative delivery vehicles based on risk factor data obtained from sensed conditions sensed during delivery.

Aspect 55. A method for wireless communications at a device associated with a user, the method comprising: transmitting, by the device to a network entity associated with a delivery service, a set of delivery criteria comprising delivery instructions for delivery of one or more assets for the user; and receiving, by the device from the network entity, a delivery notification comprising delivery information, wherein an amount of the delivery information in the delivery notification is based on a level of service associated with the user.

Aspect 56. The method of Aspect 55, wherein an amount of the delivery instructions in the set of delivery criteria is based on the level of service associated with the user.

Aspect 57. The method of any one of Aspects 55 or 56, wherein the level of service associated with the user is one of a basic level of service or a priority level of service.

Aspect 58. The method of Aspect 57, wherein the priority level of service is associated with a higher amount of the delivery instructions than an amount of the delivery instructions associated with the basic level of service.

Aspect 59. The method of Aspect 58, wherein the delivery instructions for the user with the priority level of service comprise a destination location, a time of delivery, and a delivery path.

Aspect 60. The method of Aspect 59, wherein the delivery instructions for the user with the priority level of service further comprises at least one of a level of care of handling during transport, a temperature range during the transport, an avoidance of roads with poor driving conditions, asset characteristics, or at least one type of delivery vehicle.

Aspect 61. The method of Aspect 60, wherein the one at least one type of delivery vehicle comprises at least one of a truck, a car, a train, a ship, or a human deliverer.

Aspect 62. The method of any one of Aspects 57 to 61, wherein the priority level of service is associated with a higher amount of the delivery information in the delivery notification than an amount of delivery information for a delivery notification associated with the basic level of service.

Aspect 63. The method of Aspect 62, wherein the delivery information for the user with the priority level of service comprises a time of delivery and a delivery path.

Aspect 64. The method of Aspect 63, wherein the delivery information for the user with the priority level of service further comprises at least one of environmental information, temperature information, battery percentage of an associated monitoring device, delivery substation details, fuel details, a type of delivery vehicle, or a change in the delivery path.

Aspect 65. A non-transitory computer-readable medium having stored thereon instructions that, when executed by at least one processor, cause the at least one processor to perform operations according to any of Aspects 33 to 54.

Aspect 66. An apparatus for wireless communications, comprising one or more means for performing operations according to any of Aspects 33 to 54.

Aspect 67. A non-transitory computer-readable medium having stored thereon instructions that, when executed by at least one processor, cause the at least one processor to perform operations according to any of Aspects 55 to 64.

Aspect 68. An apparatus for wireless communications, comprising one or more means for performing operations according to any of Aspects 55 to 64.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

1. A network entity associated with a delivery service, the network entity comprising:
at least one memory; and
at least one processor coupled to the at least one memory and configured to:
receive, from one or more devices associated with one or more users, one or more sets of delivery criteria for delivery of one or more assets for the one or more users;
determine delivery planning information for delivery of the one or more assets based on the one or more sets of delivery criteria; and
transmit, to the one or more devices associated with the one or more users, one or more delivery notifications associated with the delivery of the one or more assets, wherein delivery information of the one or more delivery notifications is based on a respective level of service associated with each user of the one or more users.

2. The network entity of claim 1, wherein each of the one or more sets of delivery criteria comprises delivery instructions for each user of the one or more users, and wherein an amount of the delivery instructions for each of the one or more sets of delivery criteria is based on the respective level of service associated with each user of the one or more users.

3. The network entity of claim 2, wherein the respective level of service associated with each user of the one or more users is one of a basic level of service or a priority level of service.

4. (canceled)

5. (canceled)

6. (canceled)

7. (canceled)

8. The network entity of claim 1, wherein an amount of the delivery information in each of the one or more delivery notifications is based on the respective level of service associated with each user of the one or more users.

9. The network entity of claim 8, wherein the respective level of service associated with each user of the one or more users is one of a basic level of service or a priority level of service.

10. The network entity of claim 9, wherein a delivery notification of the one or more delivery notifications for a user of the one or more users with the priority level of service comprises a higher amount of the delivery information than a delivery notification of the one or more delivery notifications for a user of the one or more users with the basic level of service.

11. (canceled)

12. (canceled)

13. The network entity of claim 1, wherein the at least one processor is configured to determine the delivery planning information for delivery of the one or more assets based on the respective level of service associated with each user of the one or more users.

14. The network entity of claim 1, wherein, to determine the delivery planning information for delivery of the one or more assets, the at least one processor is configured to determine a delivery path and a time of delivery for each of the one or more assets.

15. (canceled)

16. (canceled)

17. (canceled)

18. (canceled)

19. The network entity of claim 1, wherein the at least one processor is configured to determine the delivery planning information for delivery of the one or more assets further based on one or more risk factors associated with potential delivery paths for delivery of the one or more assets.

20. (canceled)

21. (canceled)

22. The network entity of claim 1, wherein at least one processor is configured to determine at least one of one or more alternative delivery paths or one or more alternative delivery vehicles based on risk factor data obtained from sensed conditions sensed during delivery.

23. A device associated with a user for wireless communications, the device comprising:
at least one memory; and
at least one processor coupled to the at least one memory and configured to:
transmit, to a network entity associated with a delivery service, a set of delivery criteria comprising delivery instructions for delivery of one or more assets for the user; and
receive, from the network entity, a delivery notification comprising delivery information, wherein an amount of the delivery information in the delivery notification is based on a level of service associated with the user.

24. The device of claim 23, wherein an amount of the delivery instructions in the set of delivery criteria is based on the level of service associated with the user.

25. The device of claim 23, wherein the level of service associated with the user is one of a basic level of service or a priority level of service.

26. The device of claim 25, wherein the priority level of service is associated with a higher amount of the delivery instructions than an amount of the delivery instructions associated with the basic level of service.

27. The device of claim 26, wherein the delivery instructions for the user with the priority level of service comprise a destination location, a time of delivery, and a delivery path.

28. The device of claim 27, wherein the delivery instructions for the user with the priority level of service further comprises at least one of a level of care of handling during transport, a temperature range during the transport, an avoidance of roads with poor driving conditions, asset characteristics, or at least one type of delivery vehicle.

29. (canceled)

30. The device of claim 25, wherein the priority level of service is associated with a higher amount of the delivery information in the delivery notification than an amount of delivery information for a delivery notification associated with the basic level of service.

31. The device of claim 30, wherein the delivery information for the user with the priority level of service comprises a time of delivery and a delivery path.

32. The device of claim 31, wherein the delivery information for the user with the priority level of service further comprises at least one of environmental information, temperature information, battery percentage of an associated monitoring device, delivery substation details, fuel details, a type of delivery vehicle, or a change in the delivery path.

33-36. (canceled)

37. A method for wireless communications at a device associated with a user, the method comprising:
transmitting, by the device to a network entity associated with a delivery service, a set of delivery criteria comprising delivery instructions for delivery of one or more assets for the user; and
receiving, by the device from the network entity, a delivery notification comprising delivery information, wherein an amount of the delivery information in the delivery notification is based on a level of service associated with the user.

38-40. (canceled)
